(19) United States
(12) Patent Application Publication
(10) Pub. No.: US 2007/0218256 A1
(43) Pub. Date: Sep. 20, 2007

(54) Image-receiving sheet for electrophotography and image forming process

(75) Inventor: Yoshio Tani, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/717,637

(22) Filed: Mar. 14, 2007

(30) Foreign Application Priority Data
Mar. 16, 2006 (JP) 2006-073585

(51) Int. Cl. G03G 15/20; B44C 1/17

(52) U.S. Cl. 428/195.1; 430/124.53; 430/124.13

(57) ABSTRACT

The present invention provides an image-receiving sheet for electrophotography that includes a support, a conductive undercoating layer, and an image-receiving layer on at least one surface of the support via the conductive undercoating layer, wherein the conductive undercoating layer includes a conductive metal oxide and a binder resin, wherein, when the conductive metal oxide has a spherical shape or an irregular shape, the number average particle diameter of the conductive metal oxide is 0.15 μm or less, and when the conductive metal oxide has a needle-shape or a substantially needle-shape, the aspect ratio, length of long axis/length of short axis, of the conductive metal oxide is 5 or more, and the length of short axis is from 0.005 μm to 0.05 μm, and wherein the image-receiving layer includes a white pigment and fine particles, and the light transmittance of the image-receiving layer is 75% or less.

### BACKGROUND OF THE INVENTION

1. Field of the Invention

The present invention relates to a high-quality image-receiving sheet for electrophotography which is excellent in toner transferability, conveyability and whiteness of the surface of the image-receiving layer and which does not cause cracks in the image when bended, and to an image forming process using the image-receiving sheet for electrophotography.

2. Description of the Related Art

An attempt has been made to form a conductive layer that contains a conductive metal oxide or conductive metal-containing particles in an image-receiving sheet for electrophotography in order to improve toner transferability and conveyability. For example, Japanese Patent Application Laid-Open (JP-A) No. 06-301152 discloses an image forming element that contains a support, an image-forming layer, and an electrically-conductive layer, wherein the electrically-conductive layer contains a film-forming hydrophilic colloid in which both electrically-conductive metal-containing particles and water-insoluble polymer particles are dispersed; the electrically-conductive metal-containing particles have an average particle size of less than 0.3 μm and constitute 10% by volume to 50% by volume of the electrically-conductive layer; the water-insoluble polymer particles have an average particle size of from 10 nm to 500 nm and are present in the electrically-conductive layer in an amount of 0.3 parts by mass to 3 parts by mass per 1 part by mass of the film-forming hydrophilic colloid.

The above-mentioned image forming element, however, has a drawback in that satisfactory toner transferability, conveyability, and whiteness required for image-receiving sheets for electrophotography are not obtained.

JP-A No. 2000-10325 discloses an image-receiving sheet for electrophotography that contains a support, on one surface thereof, at least a conductive undercoating layer and an image-receiving layer in this order, on the back surface, at least a conductive back layer, wherein the whiteness of the surface of the support, on which surface the conductive undercoating layer is formed, is 85% or more; the conductive undercoating layer contains particles of conductive metal oxide having a number average particle diameter of 0.15 μm or less and a binder resin; the conductive back layer contains particles of conductive metal oxide and a binder resin; the surface on which the image-receiving layer is formed, and the surface on which the conductive back layer is formed have a surface electrical resistance ranging from 1×10⁹ Ω/quadrature to 1×10¹⁴ Ω/quadrature (under conditions of 25° C. and 65% RH); the whiteness of the face where the image-receiving layer is formed is 80% or more; and the dynamic friction coefficient between image-receiving sheets for electrophotography is 0.50 or less.

In this image-receiving sheet for electrophotography, however, the conductive metal oxide causes coloring of the conductive undercoating layer (grey to brown), and thereby the whiteness of the surface of the image-receiving layer is reduced, resulting in lower whiteness than that of the support. In addition, the addition of the conductive metal oxide makes the conductive undercoating layer brittle, and thus cracks in the image are easily caused when bended. Further, it is difficult to form an image on the back side of the support, and thus an image cannot be formed on both surfaces.

Thus, a high-quality image-receiving sheet for electrophotography which is excellent in toner transferability, conveyability and whiteness of the surface of the image-receiving layer and which does not cause cracks in the image when bended has not yet been provided so far. It is now desired to swiftly provide such an image-receiving sheet for electrophotography.

### BRIEF SUMMARY OF THE INVENTION

It is an object of the present invention to provide a high-quality image-receiving sheet for electrophotography which is excellent in toner transferability, conveyability and whiteness of the surface of the image-receiving layer and which does not cause cracks in the image when bended, and to provide an image forming process using the image-receiving sheet for electrophotography.

The image-receiving sheet for electrophotography of the present invention includes a support, a conductive undercoating layer, and an image-receiving layer on at least one surface of the support via the conductive undercoating layer, wherein the conductive undercoating layer includes a conductive metal oxide and a binder resin, wherein, when the conductive metal oxide has a spherical shape or an irregular shape, the number average particle diameter of the conductive metal oxide is 0.15 μm or less, and when the conductive metal oxide has a needle-shape or a substantially needle-shape, the aspect ratio of the conductive metal oxide is 5 or more, and the length of short axis is from 0.005 μm to 0.05 μm, and wherein the image-receiving layer includes a white pigment and fine particles, and the light transmittance of the image-receiving layer is 75% or less.

In the image-receiving sheet for electrophotography of the present invention, the conductive undercoating layer that contains a conductive metal oxide with specific property is disposed, and the light transmittance of the image-receiving layer is 75% or less. By doing so, a high-quality image-receiving sheet for electrophotography which is excellent in toner transferability, conveyability and whiteness of the surface of the image-receiving layer, which does not cause cracks in the image when bended, and which allows for image formation on both sides can be obtained.

The image forming process of the present invention includes forming a toner image on a surface of the image-receiving sheet for electrophotography of the present invention, and fixing the toner image formed in the formation of the toner image on the image-receiving sheet for electrophotography to smooth the surface of the toner image. According to the image forming process of the present invention, simple processing makes it possible to obtain effectively a high-quality image that is dose to silver halide photography prints since the image-receiving sheet for electrophotography of the present invention is used.

### BRIEF DESCRIPTION OF THE SEVERAL VIEWS OF THE DRAWINGS

FIG. 1 is a schematic view showing an example of the apparatus configured to fix an image and smooth the image surface according to the present invention.

FIG. 2 is a schematic view showing an example of the image forming apparatus according to the present invention.

FIG. 3 is a schematic view showing an example of the apparatus configured to fix an image and smooth the image surface of the image forming apparatus in FIG. 2.

FIG. 4 is a schematic cross-sectional view showing an outline of an apparatus for measuring a dynamic friction coefficient between image-receiving sheets for electrophotography.

### DETAILED DESCRIPTION OF THE INVENTION

(Image-Receiving Sheet for Electrophotography)

The image-receiving sheet for electrophotography of the present invention contains a support, a conductive undercoating layer, an image-receiving layer on at least one surface of the support via the conductive undercoating layer and optionally other layers in accordance with the necessity. In addition, the image-receiving layer may be disposed to both surfaces of the support via the conductive undercoating layer, by which image can be formed on both sides. When the conductive undercoating layer and the image-receiving layer are disposed to both surfaces, it is preferable to form conductive undercoating layers and image-receiving layers similar to the conductive undercoating layer and the image-receiving layer that will be described below.

<Conductive Undercoating Layer>

The conductive undercoating layer contains at least a conductive metal oxide and a binder resin, and optionally other components.

The conductive metal oxide used for the conductive undercoating layer may have any shape including a spherical shape, a needle-shape, and an irregular shape. The size of the conductive metal oxide is preferably small in order to make light scattering as little as possible and to prevent the reduction of the whiteness of the entire image-receiving sheet for electrophotography.

When the conductive metal oxide has a spherical shape or an irregular shape, the number average particle diameter is required to be 0.15 μm or less, preferably from 0.01 μm to 0.10 μm, and more preferably from 0.01 μm to 0.05 μm. When the number average particle diameter is more than 0.15 μm, light scattering intensity becomes large, resulting in coloring of the conductive undercoating layer. In addition, such conductive metal oxide may not be dispersed in a solvent (e.g. water) easily. When particles of conductive metal oxide have an irregular shape, as the number average particle diameter, a number average particle diameter in terms of an equivalent sphere is applied. The number average particle diameter can be determined, for example, by a Coulter counter method.

When the particles of conductive metal oxide have a needle-shape or a substantially needle-shape, the aspect ratio (length of long axis/length of short axis) is required to be 5 or more, and the length of short axis is required to be from 0.005 μm to 0.05 atm. The aspect ratio is preferably 10 or more and more preferably 15 or more. The length of short axis is preferably from 0.007 μm to 0.03 μm, and more preferably from 0.01 μm to 0.02 μm.

The length of long axis is preferably from 0.1 μm to 3.0 μm, more preferably from 0.15 μm to 2.5 μm, and still more preferably from 0.2 μm to 2.0 μm.

When the aspect ratio is less than 5, the characteristics of the needle-shape are lost, conductive effect relative to the blended amount may be reduced. When the length of short axis is less than 0.005 μm, the form is likely to be broken, which makes it difficult to form certain needle-shape. When it is more than 0.05 μm, colorless transparency which is characteristic to the needle-shape may be degraded. The aspect ratio can be determined, for example, by an electron microscope method.

Examples of the conductive metal oxide include ZnO, TiO₂, SnO₂, Al₂O₃, In₂O₃, SiO₂, MgO, BaO, WO₃, and MoO₃. These may be used alone or composite oxides of these may be used. Among these, those containing mainly an oxide of at least one metal selected from the group consisting of Zn, Ti, Sn, In, Si, Mo, and W, or at least one metal composite oxide that is composed of the oxides.

Preferably, the conductive metal oxide further contains another different element. For example, ZnO containing or doped with Al and In; TiO₂ containing or doped with Nb and Ta; SnO containing or doped with Sb, Nb and a halogen element are preferable. Among these, SnO₂ doped with Sb is most preferable in terms of production cost since variation in conductivity is small and stability is high.

The content of the conductive metal oxide in the conductive undercoating layer is preferably 1% by mass to 80% by mass, and more preferably 10% by mass to 50% by mass.

—Binder Resin—

The binder resin is not particularly limited and may be suitably selected in accordance with the intended use, but water soluble resins are suitable. Examples of the water soluble resin include polyvinyl alcohol, polyacrylic acid, polyacrylamide, polyhydroxyethyl acrylate, polyvinyl pyrrolidone, water soluble polyester, water soluble polyurethane, water soluble nylon, water soluble epoxy resin, gelatin, hydroxyethylcellulose, hydroxypropylcellulose, carboxymethylcellulose, and derivatives thereof.

In addition, examples of the polymer other than the above-mentioned water soluble resins include acrylic resin, polyester, polyvinyl acetate, and SBR (styrene-butadiene rubber). In general, it is preferable to use these as a polymer aqueous dispersion or an emulsion.

In the present invention, in particular, it is preferable to use these polymers as a polymer aqueous dispersion. Water dispersible polymers such as acrylic resin and polyester are preferable polymers for the polymer aqueous dispersion. The water dispersible polymer preferably comprises in the molecule a polar group (for example, quaternary ammonium base, sulfonic acid group, sulfonic acid base, carboxylic acid group, carboxylic acid base, phosphate acid group, phosphoric acid base) in an amount ranging from 0.1% by mass to 10% by mass, and more preferably in an amount ranging from 1% by mass to 5% by mass. For the polar group, ammonium carboxylate is preferable. In particular, for the conductive undercoating layer, an acrylic resin is preferable. Further, a crosslinking agent, surfactant, or the like may be added to these polymers.

For the binder resin, a commercially available one can be used. Examples thereof include HIROS HE-1335, HIROS BH-997L, HIROS HE-1066, and HIROS HE-1335 (manufactured by SEIKO PMC CORPORATION); and Nipol SX-1503 (manufactured by ZEON CORPORATION).

The conductive undercoating layer may optionally contain other components such as a releasing agent, a plasticizer, a coloring agent, a filler, a crosslinking agent, a charge adjusting agent, an emulsifier, and a dispersing agent as long as the function of the undercoating layer is not adversely affected.

The conductive undercoating layer is formed, for example, by preparing a coating solution for conductive undercoating layer, and applying the coating solution on a support. The coating method is not particularly limited and may be suitably selected in accordance with the intended use. Examples thereof include a blade coating method, an air knife coating method, a gravure coating method, a roll coating method, a spray coating method, a dip coating method, a bar coating method, an extrusion coating method, and a spin coating method.

The thickness of the undercoating layer is not particularly limited and may be suitably selected in accordance with the intended use; for example, it is preferably from 0.01 μm to 1.00 μm, and more preferably from 0.05 μm to 0.5 μm.

The breaking extension of the conductive undercoating layer is preferably 20% or more, more preferably 25% or more, and still more preferably 80% or more. The upper limit of the breaking extension is not particularly limited and may be suitably selected in accordance with the intended use, but 430% or less is preferable. When the breaking extension is less than 20%, it may result in increased crazing when a sheet is bent.

The breaking extension can be determined, for example, as follows. A composition for conductive undercoating layer is applied on a hydrophobic support with a wire bar such that the thickness is 10 μm to 40 μm, and dried to form a conductive undercoating layer. A 5×70 mm strip is cut out as a sample from this conductive undercoating layer, and the measurement is performed for the sample using Tensilon (RTM-50, manufactured by Orientec Co., Ltd.) under the tensile strength of 500 mm/min. The extension at the time when the sample has broken relative to an initial sample length is determined as an extended amount (%), or breaking extension.

The surface electrical resistance of the conductive undercoating layer is different depending on the type, thickness, etc. of binder resin, but is preferably in the range of from 1×10⁸ Ω/quadrature to 1×10¹³ Ω/quadrature under conditions of 25° C. and 55% RH).

The surface electrical resistance can be measured, for example, according to the method described in JIS K 6911 as follows. The sample of the conductive undercoating layer is left under the condition where the temperature is 20° C. and the humidity is 65% for 8 hours or more and after applying a voltage of 100 V to the sample of the conductive undercoating layer for 1 minute under the same condition as the above-noted condition, the surface electrical resistance of the conductive undercoating layer can be measured using a micro-ammeter R8340 (manufactured by Advantest Ltd.).

<Support>

The support is not particularly limited and may be suitably selected from among those known as a support of an image-receiving sheet for electrophotography depending on the application. Examples thereof include raw paper, synthetic paper, synthetic resin sheet, coated paper, and laminated paper. Among these, coated paper comprising polyolefin resin layers formed to both surfaces of raw paper is most preferable. These supports may have a single-layer structure or a laminated structure of two or more layers.

—Raw Paper—

The raw paper is not particularly limited and may be suitably selected in accordance with the intended use. Preferred specific examples of the raw paper include a woodfree paper, such as a paper described in the literature “Basis of Photographic Technology-silver halide photograph (edited by The Society of Photographic Science and Technology of Japan and published by Corona Publishing Co., Ltd. (1979) (pp. 223-22⁴)”.

The raw paper, used for a support is not particularly limited as long as it is a well-known material and may be suitably selected from all types of materials in accordance with the intended use, for example, natural pulp of conifer and broadleaf tree, and a mixture of the natural pulp and synthetic pulp, are suitable.

The pulp that can be used as the material of the raw paper is desirable to be bleached broadleaf tree kraft pulp (LBKP), but bleached conifer kraft pulp (NBKP) and broadleaf tree sulfite pulp (LBSP) may also be used because they enhance the surface smoothness, rigidity and dimension stability (curl property) of the raw paper at the same time with good balance and to sufficient level.

As the beating of the pulp, a beater and a refiner may be used.

The Canada Standard Filtered Water Degree of the pulp is preferably 200 ml to 440 ml C.S.F., and more preferably 250 ml to 380 ml C.S.F. because in paper making, the shrinkage of the paper can be controlled.

Various additives, for example, fillers, dry paper reinforcers, sizing agents, wet paper reinforcers, fixing agents, pH regulators or other agents, or the like may be added, if necessary, to the pulp slurry (hereafter, may be referred to as “pulp paper material”) which is obtained after beating the pulp.

Examples of the fillers include calcium carbonate, clay, kaolin, white clay, talc, titanium oxide, diatomaceous earth, barium sulfate, aluminum hydroxide, and magnesium hydroxide.

Examples of the dry paper reinforcers include cationic starch, cationic polyacrylamide, anionic polyacrylamide, amphoteric polyacrylamide, and carboxy-modified polyvinyl alcohol.

Examples of the sizing agents include higher fatty acid salt; rosin derivatives such as rosin, maleic rosin or the like; paraffin wax, alkyl ketene dimer, alkenyl succinic anhydride (ASA); and higher fatty acid such as epoxidized fatty amide.

Examples of the wet paper reinforcers include polyamine polyamide epichlorohydrin, melamine resin, urea resin, and epoxy polyamide resin.

Examples of the fixing agents include polyvalent metal salt such as aluminum sulfate, aluminum chloride, or the like; and cationic polymers such as cationic starch, or the like.

Examples of the pH regulators include caustic soda, and sodium carbonate.

Examples of other agents include defoaming agents, dyes, slime control agents, and fluorescent whitening agents.

In accordance with the necessity, the pulp slurry may contain a flexibilizer. Examples of the flexibilizer include agents described in the literature “Paper and Paper Treatment Manual (published by Shiyaku Time Co., Ltd. (1980) (pp. 554-555)).

These various additives may be used alone or in combination. Also, the amount of these various additives to be added to the pulp paper material is not limited and may be suitably selected in accordance with the intended use, generally, preferably 0.1% by mass to 1.0% by mass.

The pulp paper material which is optionally prepared by incorporating the various additives into the pulp slurry is subjected to the papermaking using a paper machine, such as a manual paper machine, a Fourdrinier (long-net) paper machine, a round-net paper machine, a twin-wire machine and a combination machine, and the made paper is dried to produce the raw paper. If desired, either before or after the drying of the made paper, the made paper may be subjected to the surface sizing treatment.

The treating liquid used for the surface sizing treatment is not limited and may be suitably selected in accordance with the intended use. Examples of the compound contained in the treating liquid include a water-soluble polymer, a waterproof compound, a pigment, a dye and a fluorescent whitening agent.

Examples of the water-soluble polymer include a cationic starch, a polyvinyl alcohol, a carboxy-modified polyvinyl alcohol, a carboxymethylcellulose, a hydroxyethylcellulose, a cellulose sulfate, gelatin, casein, a sodium polyacrylate, a sodium salt of styrene-maleic anhydride copolymer and a sodium salt of polystyrene sulfonic acid.

Examples of the waterproof compound include latexes and emulsions, such as a styrene-butadiene copolymer, an ethylene-vinyl acetate copolymer, a polyethylene and a vinylidene chloride copolymer; and a polyamidepolyamineepichlorohydrin.

Examples of the pigment include calcium carbonate, clay, kaolin, talc, barium sulfate and titanium oxide.

From the viewpoint of improving stiffness and dimension stability (curling properties) of the raw paper, it is preferred that the raw paper has the ratio (Ea/Eb) between the longitudinal Young's modulus (Ea) and the lateral Young's modulus (Eb) of from 1.5 to 2.0. When the ratio (Ea/Eb) is less than 1.5 or more than 2.0, the stiffness and the curling properties of the image-receiving sheet for electrophotography may be easily impaired, and then a disadvantage is caused wherein the conveyability of the image-receiving sheet for electrophotography is hindered.

Generally, it has been clarified that the “nerve” of the paper is varied depending on the method for beating the pulp and as an important index indicating the “nerve” of the paper, the modulus of elasticity of the paper made by the papermaking after the beating of the pulp, can be used. The modulus of elasticity of the paper can be calculated according to the following equation 1:
E=ρc²(1−n²) [Equation 1]

where “E” represents dynamic modulus, “ρ” represents the density of the paper, “c” represents the velocity of sound in the paper, and “n” represents the Poisson's ratio, by using the relation between the dynamic modulus of the paper indicating the properties as a viscoelastic body and the density of the paper, and the velocity of sound in the paper measured using an ultrasonic oscillator.

In addition, since n=0.2 or so with respect to an ordinary paper, there is not much difference between the calculation of the dynamic modulus according to the equation 1 and the calculation according to the following equation 2:
E=ρc². [Equation 2]

Accordingly, when the density of the paper and the velocity of sound in the paper can be measured, the elastic modulus of the paper can be easily calculated. For measuring the velocity of sound in the paper, various conventional instruments such as a SONIC TESTER SST-110 (manufactured by Nomura Shoji Co., Ltd.) can be used.

For smoothing the surface of the raw paper, it is preferred that the raw paper is produced, as described in JP-A No. 58-68037, using a pulp fiber having a fiber length distribution in which a total of a 24 mesh screen remnant and a 42 mesh screen remnant is from 20% by mass to 45% by mass and a 24 mesh screen remnant is 5% by mass or less, based on the mass of all pulp fibers. Moreover, [Equation 2]the mean center line roughness of the raw paper can be controlled by subjecting the raw paper to a surface treatment by applying the heat and pressure using a machine calendar or a super calendar.

The thickness of the raw paper is not particularly limited and may be suitably selected in accordance with the intended use, however, it is preferably 30 μm to 500 μm, more preferably 50 μm to 300 μm, and still more preferably 100 μm to 250 μm. The basis weight is not particularly limited and may be suitably selected in accordance with the intended use, however, it is preferably 50 g/m² to 250 g/m², and more preferably 100 g/m²to 200 g/m².

—Synthetic Paper—

The synthetic paper is paper that is mainly composed of polymer fiber other than cellulose. Examples the polymer fiber include polyolefin fibers such as polyethylene and polypropylene.

—Synthetic Resin Sheet (Film)—

The synthetic resin sheet (film) includes synthetic resins in sheet form. Examples thereof include polypropylene film, stretched polyethylene film, stretched polypropylene film, polyester film, stretched polyester film and nylon film. White-colored films by stretching, white films containing white pigment, and the like may also be used.

—Coated Paper—

The coated paper is one produced by coating various resins on at least one of one surface and both surfaces of a substrate such as raw paper, and the coating amount differs depending on the application. Examples of the coated paper include art paper, cast coated paper, and Yankee paper.

The resin, with which the surface of the raw paper or the like is coated, is not particularly limited and may be suitably selected in accordance with the intended use, however, thermoplastic resins are suitable. Examples of the thermoplastic resin include (1) polyolefin resins, (2) polystyrene resins, (3) acrylic resins, (4) polyvinyl acetate and the derivatives, (5) polyamide resins, (6) polyester resins, (7) polycarbonate resins, (8) polyether resins (or acetal resins), and (9) other resins. These thermoplastic resins may be used alone or in combination.

Examples of the polyolefin resins (1) include a polyolefin resin, such as a polyethylene and a polypropylene; and a copolymer resin produced by copolymerizing an olefin, such as ethylene and propylene with another vinyl monomer. Examples of such a copolymer resin (produced by copolymerizing an olefin with another vinyl monomer) include an ethylene-vinyl acetate copolymer and an ionomer resin which is produced by copolymerizing an olefin with acrylic acid or methacrylic acid. Examples of the derivatives of the polyolefin resins include a chlorinated polyethylene and a chlorosulfonated polyethylene.

Examples of the polystyrene resins (2) include a polystyrene resin, a styrene-isobutylene copolymer, an acrylonitrile-styrene copolymer (AS resin), an acrylonitrile-butadiene-styrene copolymer (ABS resin) and a polystyrene-maleic anhydride resin.

Examples of the acrylic resins (3) include a polyacrylic acid and esters thereof, a polymethacrylic acid and esters thereof, a polyacrylonitrile and a polyacrylamide. The polyacrylic acid esters and polymethacrylic acid esters differ greatly in properties according to the type of ester group. Also, they may be copolymer with other monomers (e.g., acrylic acid, methacrylic acid, styrene, and vinyl acetate). The polyacrylonitrile is often used as a copolymer of the above-mentioned AS resin and ABS resin rather than as a polymer.

Examples of the polyvinyl acetate and derivatives thereof (4) include a polyvinyl acetate, a polyvinyl alcohol produced by saponifying the polyvinyl acetate and a polyvinylacetal resin produced by reacting the polyvinyl alcohol with an aldehyde (e.g., formaldehyde, acetaldehyde and butyraldehyde).

The polyamide resins (5) are polycondensates of a diamine and a dibasic acid and examples thereof include 6-nylon and 6,6-nylon.

The polyester resins (6) are polycondensates of an alcohol and an acid, and the properties of the polyester resin are largely varied depending on the combination of an acid and an alcohol. The polyester resin (6) may be general use resin such as polyethylene terephthalate and polybutylene terephthalate from aromatic dibasic acid and dihydric alcohol.

General examples of the polycarbonate resin (7) include a polycarbonate ester produced from bisphenol A and phosgene.

Examples of the polyether resin (or the acetal resin) (8) include a polyether resin, such as a polyethylene oxide and a polypropylene oxide (or an acetal resin produced by a ring opening polymerization, such as a polyoxymethylene).

The other resins (9) include a polyurethane resin produced by an addition polymerization.

A whitening agent, a conductive agent, a filler, a pigment such as titanium oxide, ultramarine blue, and carbon black, and a dye may further be incorporated in the thermoplastic resin in accordance with the necessity.

—Laminated Paper—

The laminated paper is a paper formed by laminating a laminating material including a variety of resin, rubber or polymer sheets or films on a substrate such as raw paper. Examples of the laminating material include polyolefin resin, polyvinyl chloride resin, polyester resin, polystyrene resin, polymethacrylate resin, polycarbonate resin, polyimide resin, and triacetyl cellulose. These resins may be used alone, or in combination.

The polyolefin resin, generally, is often formed by using low density polyethylene resin, however, in order to increase the heat resistance of the support, it is preferable to use polypropylene, a blend of polypropylene and polyethylene, high-density polyethylene, and a blend of high-density polyethylene and low-density polyethylene. From the point of cost and laminated properties, using the blend of high-density polyethylene and low-density polyethylene is the most preferable in particular.

The high-density polyethylene and the low-density polyethylene preferably have a blend ratio (mass ratio) of 1/9 to 9/1, more preferably 2/8 to 8/2, and still more preferably 3/7 to 7/3. When forming thermoplastic resin layer on both sides of the raw paper, the back surface of the raw paper, which is the opposite surface of the image-receiving layer being disposed, for example, it is preferable to form using high-density polyethylene, or a blend of high-density polyethylene and low-density polyethylene.

For any one of high-density polyethylene and low-density polyethylene, the melt index of the polyolefin resin is preferably 1.0 g/10 min to 40 g/10 min, and polyolefin resin that has extrusion suitability is preferable.

The weight average molecular mass of the polyolefin resin is not particularly limited as long as it allows for extrusion coating, and may be suitably selected in accordance with the intended use. For example, the polyolefin resin preferably has a weight average molecular mass ranging from 20,000 to 200,000.

It is preferable that the polymer coating layer at least on one surface of the paper, and preferably the polymer coating layer on both surfaces of the paper is formed using a blend of a high-density polyethylene and a low-density polyethylene.

The resin density of the low-density polyethylene (LDPE) is preferably 0.930 g/cm³ or less, and more preferably 0.925 g/cm³ or less.

The resin density of the high-density polyethylene (HDPE) is preferably 0.945 g/cm³ or more.

These sheets or films may be applied a treatment so as to take a reflectivity against white color. Examples of such treatment include compounding a pigment such as titanium oxide or the like into the sheets or films.

The thickness of the support is not limited and may be suitably selected according to the purpose, however, it is preferably 25 μm to 300 μm, more preferably 50 μm to 260 μm, and still more preferably 75 μm to 220 μm.

<Image-Receiving Layer>

The image-receiving layer is formed to receive color toners and a black toner and form an image using the toners. The image-receiving layer has functions to receive a toner forming an image from a developing drum or an intermediate transfer member by effect of (static) charge, and/or pressure, or the like in a image-transferring step, and to solidify the image by effect of heat and/or pressure, and the like in a fixing step.

The light transmittance of the image-receiving layer is preferably 75% or less, more preferably 73% or less, and still more preferably 72% or less. When the light transmittance is more than 75%, coloring of the conductive undercoating layer may be noticed easily.

The light transmittance of the image-receiving layer can be measured, for example, by forming an image-receiving layer having a thickness of 100 μm on the polyethylene terephthalate film having a thickness of 100 μm, and measuring the light transmittance of the image-receiving layer using a direct reading haze meter (HGM-2DP, manufactured by Suga Tester Co., Ltd.).

The whiteness W_{S} of the surface of the support and the whiteness W_{R} of the surface of the image-receiving layer preferably satisfy: |W_{S}−W_{R}|≦0.5, and more preferably satisfy: W_{S}−W_{R}≦0.5. When the |W_{S}−W_{R}| exceeds 0.5, nonuniformity of whiteness may be generated easily.

Here, the whiteness of the support and image-receiving layer is determined, for example, according to the method defined in JIS P8123 as follows. Using a Hunter whiteness tester, a ratio (%) of the reflectance when the support or image-receiving layer of a sample is irradiated with blue-violet light of the spectrum, to the reflectance obtained when a standard magnesium oxide plate is irradiated with the same light is measured.

The image-receiving layer comprises at least a white pigment and fine particles, and optionally a polymer for image-receiving layer and other components.

—White Pigment—

The white pigment is not particularly limited and may be suitably selected in accordance with the intended use. Examples thereof include titanium oxide (TiO₂), zinc oxide (ZnO), white lead (2PbCO₃.Pb(OH)₂), basic lead sulfate (3PbSO₄.PbO−2PbSO₄.PbO), zinc sulfate (PbSO₄), lithopone (ZnS+BaSO₄), zinc sulfide (ZnS), antimony oxide (Sb₂O₃), zirconia (ZrO₂), calcium carbonate (CaCO₃), and kaolin (Al₂Si₂O₅(OH)₄). Among these, titanium oxide (TiO₂) is particularly preferable due to high obliterating power.

The content of the white pigment in the image-receiving layer is preferably 0.5% by mass to 50% by mass.

—Fine Particles—

The fine particles project from the outermost surface of the image-receiving sheet for electrophotography of the present invention and the particle size distribution (arithmetic standard deviation/arithmetic volume average diameter) of the projecting particles is preferably 0.4 or less, and more preferably 0.3 or less. Increased particle size distribution (wide spread in particle size), more than 0.4, causes transfer errors of toner during image formation at the site where large particles are present, and thus a high-quality image may not be obtained.

The particle serves, for example, as a matting agent to be added to any one of layers (e.g. the image-receiving layer, the intermediate layer) in order to prevent offset of the image-receiving layer. The particle to be used as the matting agent is not particularly limited and may be suitably selected from among those known in the art, and is classified into inorganic particles and organic particles.

Examples of the inorganic particle include oxides such as silicon dioxide, titanium oxide, magnesium oxide, and aluminum oxide; alkaline earth metal salts such as barium sulfate, calcium carbonate, and magnesium sulfate; silver halides such as silver chloride, and silver bromide; and glass.

Examples of the inorganic matting agent, in which the inorganic particles are used, include those disclosed in West German Patent No. 2529321, U.K. Patent Nos. 760775 and 1260772, and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245, and 4,029,504.

Examples of the organic particle include starch, cellulose ester (e.g., cellulose acetate propionate), cellulose ether (e.g., ethyl cellulose) and synthetic resin. The synthetic resin is preferably insoluble or difficult to be solved in water. Examples of the synthetic resin insoluble or difficult to be solved in water, include poly(meth)acrylic acid ester, poly(meth)acrylamide, polyvinyl esters such as polyvinyl acetate; polyacrylonitrile, polyolefins such as polyethylene; polystyrene resin, benzoguanamine resin, formaldehyde condensation polymer, epoxy resin, polyamide resin, polycarbonate resin, phenolic resin, polyvinyl carbazole resin, and polyvinylidene chloride resin. Examples of the poly(meth)acrylic acid ester include polyalkyl (meth)acrylate, polyalkoxyalkyl (meth)acrylate, and polyglycidyl (meth)acrylate.

Copolymers composed of a combination of monomers for use in the above-mentioned polymers may be used. In the case of the copolymers, a small amount of hydrophilic recurring units may be included. Examples of the monomer which constitutes the hydrophilic recurring unit include acrylic acid, methacrylic acid, α,β-unsaturated dicarboxylic acid, hydroxyalkyl (meth)acrylate, sulfoalkyl (meth)acrylate, and styrene sulfonic acid.

Examples of the organic matting agent, in which the organic particles are used, include those described in U.K. Patent No. 1055713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821, and 57-14835.

Also, two or more different particles may be added in combination.

The particle diameter of the particles is not particularly limited as long as it is larger than the thickness of the image-receiving layer, and may be suitably selected in accordance with the intended use. For example, the particle diameter of the particles is preferably 1 μm to 100 μm, and more preferably 3 μm to 30 μm. When the particle diameter is smaller than the thickness of the image-receiving layer, adhesion resistance may be reduced.

The amount of the particles to be used is not particularly limited and may be suitably selected in accordance with the intended use, and is preferably 0.01 g/m² to 0.5 g/m², and more preferably 0.02 g/m² to 0.3 g/m².

—Polymer for Image-Receiving Layer—

The polymer for image-receiving layer is not particularly limited and may be suitably selected from among conventional polymers depending on the application; for example, thermoplastic resins are suitable. As the thermoplastic resin, thermoplastic resins similar to those described of (1) to (9) of the coated paper of the support can be used.

Of these, styrene resins, acrylic resins, styrene-acrylic acid resins, polyester resins each having a large amount of cohesive energy are preferably used from the perspective of embedding of a toner in the resin.

Examples of the styrene resins include a polystyrene homopolymer, a styrene-isobutylene copolymer, a styrene-butadiene copolymer, an acrylonitrile-styrene copolymer (AS resin), an acrylonitrile-butadiene-styrene copolymer (ABS resin) and a polystyrene-maleic anhydride resin.

Examples of the acrylic resins include a polyacrylic acid and esters thereof, a polymethacrylic acid and esters thereof, a polyacrylonitrile and a polyacrylamide.

Examples of the esters of polyacrylic acid include homopolymers and copolymers of esters of acrylic acids. Examples of the esters of acrylic acids include methyl acrylate, ethyl acrylate, n-butyl acrylate, isobutyl acrylate, dodecyl acrylate, n-octyl acrylate, 2-ethylhexyl acrylate, 2-chlorethyl acrylate, phenyl acrylate, and α-chlormethyl acrylate. Examples of the esters of polymethacrylic acids include homopolymers and copolymers of esters of methacrylic acids. Examples of the esters of methacrylic acid include methyl methacrylate, ethyl methacrylate, and butyl methacrylate.

Examples of the styrene-acrylic acid resins include copolymers of styrene and the esters of acrylic acids, and copolymers of styrene and methacrylic acid.

The polyester resin is produced by a polycondensation between an acid component and an alcohol component. The acid component is not particularly limited and may be suitably selected in accordance with the intended use, and examples thereof include maleic acids, fumaric acid, citraconic acid, itaconic acid, gulutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecenylsuccinic acid, isododecenylsuccinic acid, n-octenylsuccinic acid, n-octenylsuccinic acid, isooctenylsuccinic acid, isooctenylsuccinic acid, trimellitic acid, and pyromellitic acid; and acid anhydrides thereof or lower alkyl esters thereof.

The alcohol component is not particularly limited and may be suitably selected in accordance with the intended use. For example, a divalent alcohol is preferable. Examples of the aliphatic diols include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol. Examples of the alkylene oxide adduct of bisphenol A include polyoxyproplylene (2.2)-2,2-bis(4-hydroxyphenyl)propane, polyoxypropylene (3.3) -2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, and polyoxypropylene (6) -2,2-bis (4-hydroxyphenyl) propane.

For the polymer for image-receiving layer, a polymer capable of satisfying physical properties of the image-receiving layer, which will be hereinafter described, in a state where the image-receiving layer is formed is preferably used, a polymer capable of satisfying the physical properties of the image-receiving layer even with the use of the resin alone is more preferably used. It is also preferable to use two or more different resins which are different in the physical properties of the image-receiving layer.

For the polymer for image-receiving layer, a polymer having a molecular mass greater than that of the thermoplastic resin used in the toner is preferable. However, the relation of the molecular mass is not necessarily preferable depending on the relation of thermodynamic properties of the thermoplastic resin used in the toner and the polymer for image-receiving layer. For example, when the softening temperature of the polymer for image-receiving layer is higher than that of the thermoplastic resin used in the toner, there may be cases where it is preferable that the molecular mass of the polymer for image-receiving layer is equal to that of the thermoplastic resin used in the toner, or the molecular mass of the polymer for image-receiving layer is smaller than that of the thermoplastic resin used in the toner.

As a polymer for image-receiving layer, it is preferable to use a mixture of resins which have the same composition and differ in the average molecular mass from each other. For the relation of molecular mass of the thermoplastic resin used in the toner, a relation disclosed in Japanese Patent Application Laid-Open (JP-A) No. 08-334915 is preferable.

The molecular mass distribution of the polymer for image-receiving layer is preferably wider than that of the thermoplastic resin used in the toner.

It is preferable that the polymer for image-receiving layer satisfies physical properties disclosed in Japanese Patent Application Laid-Open (JP-A) Nos. 05-127413, 08-194394, 08-334915, 08-334916, 09-171265, and 10-221877.

The polymer for image-receiving layer has a glass transition temperature (Tg) preferably of 35° C. or more, and more preferably of 50° C. or more (however, 100° C. or less is appropriate). When the glass transition temperature (Tg) is less than 35° C., the coated image-receiving layer may have poor adhesion resistance.

The glass transition temperature (Tg) of the polymer for image-receiving layer is preferably 35° C. or more, but the polymer for image-receiving layer is not particularly limited if it can receive toner by deforming at the fixing temperature, and may be suitably selected in accordance with the intended use. For example, the polymer for image-receiving layer is preferably a resin of the same type as that of the resin used as a binder of toner. As the binder of toner, a polyester resin, a styrene-acrylic ester copolymer, a styrene-methacrylate ester copolymer, and the like are typically used. Thus, as the polymer for image-receiving layer of the present invention, thermoplastic resins such as a polyester resin, a styrene-acrylic ester copolymer, and a styrene-methacrylate ester copolymer are preferably used, for example.

For the polymer for image-receiving layer, (i) it causes no discharge of organic solvents in coating and drying step and is excellent in environmental suitability, and working suitability. An aqueous resin such as a water dispersible polymer and a water-soluble polymer is suitably used for the following reasons. (ii) Many of releasing agents such as waxes are hardly insoluble in a solvent at room temperature, and in many cases, a releasing agent is dispersed in a solvent (water, organic solvent) beforehand for use. A releasing agent in a water dispersion form is more excellent in stability and production step suitability. Further, in an aqueous coating treatment, a wax more easily bleeds out to the surface in the course of coating and drying the surface, and then effects of the releasing agent such as antioffset properties and adhesion resistance can be readily obtained.

The aqueous resin is not particularly limited as to the composition, binding structure, molecular structure, molecular mass, molecular mass distribution, form, etc., as long as the aqueous resin is one of a water dispersible polymer and a water-soluble polymer, and may be suitably selected in accordance with the intended use. Examples of hydrated groups of the polymer include sulfonic groups, hydroxyl groups, carboxylic groups, amino groups, amide groups, and ether groups.

For the water dispersible polymer, two or more water dispersible polymers can be selected from resins or emulsions prepared by dispersing any one of the thermoplastic resins (1) to (9) as used in the coated paper in water, copolymers thereof, mixtures thereof, and cation-modified products, in combination.

For the water dispersible polymer, a suitably synthesized one may be used, or a commercially available product may be used. Examples of the commercially available product include water dispersible polyester polymers such as BYRONAL series manufactured by TOYOBO Co., Ltd., PESRESIN A series manufactured by Takamatsu Oil & Fat Co., Ltd., TAFTON® UE series manufactured by KAO Corporation, POLYESTER WR series manufactured by Nippon Synthetic Chemical Industry Co., Ltd., and ELIETEL series manufactured by UNITIKA Ltd.; and water dispersible acrylic resins such as HIROS XE, KE, and PE series manufactured by SEIKO PMC CORPORATION, and JULIMER ET series manufactured by Nihon Junyaku Co., Ltd.

The water dispersible emulsion is not particularly limited and may be suitably selected in accordance with the intended use. Examples thereof include water dispersible polyurethane emulsions, water dispersible polyester emulsions, chloroprene emulsions, styrene-butadiene emulsions, nitrile-butadiene emulsions, butadiene emulsions, butadiene emulsions, vinylchloride emulsions, vinylpyridine-styrene-butadiene emulsions, polybutene emulsions, polyethylene emulsions, vinylacetate emulsions, ethylene-vinylacetate emulsions, vinylidene chloride emulsions, and methyl methacrylate-butadiene emulsions. Of these, water dispersible polyester emulsions are particularly preferable.

The water dispersible polyester emulsion is preferably a self-dispersible aqueous polyester emulsion. Of these, a carboxyl group-containing self-dispersible aqueous polyester emulsion is particularly preferable. Here, the self-dispersible aqueous polyester emulsion means an aqueous emulsion containing a polyester resin which is self-dispersible in an aqueous solvent without using an emulsifier or the like. The carboxyl group-containing self-dispersible aqueous polyester resin emulsion means an aqueous emulsion containing a polyester resin which contains a carboxyl group as a hydrophilic group and is self-dispersible in an aqueous solvent.

For the self-water dispersible polyester emulsion, the one that can meet the following characteristics (1) to (4) is preferable. The self-water dispersible polyester emulsion is a self-dispersible polyester emulsion prepared without using a surfactant, and thus it has low-hygroscopicity under high-humidity atmosphere, less cause decreases in softening point attributable to moisture, and can prevent offset occurrences in fixing step and occurrences of inter-sheet adhesion troubles when stored. In addition, a self-water dispersible polyester emulsion is excellent in environmental properties, and workability. Further, a polyester resin that can easily take a molecular structure having a high-cohesive energy is used therein, a self-water dispersible polyester emulsion is in a low-viscosity molten state in a fixing step of electrophotography but has a sufficient hardness in storage environment, and a toner or toners can be embedded in the image-receiving layer, thereby a sufficient high-quality image can be obtained.

(1) The number average molecular mass (Mn) of the self-water dispersible polyester emulsion is preferably 5,000 to 10,000, and more preferably 5,000 to 7,000.

(2) The molecular mass distribution (mass average molecular mass/number average molecular mass) of the self-water dispersible polyester emulsion is preferably 4 or less, and more preferably 3 or less.

(3) The glass transition temperature (Tg) of the self-water dispersible polyester emulsion is preferably 40° C. to 100° C., and more preferably 50° C. to 80° C.

(4) The volume average particle diameter of the self-water dispersible polyester emulsion is preferably 20 nm to 200 nm, and more preferably 40 nm to 150mm.

The content of the water-dispersible emulsion in the image-receiving layer is preferably 10% by mass to 90% by mass, and more preferably 10% by mass to 70% by mass.

The water-soluble polymer is not particularly limited and may be suitably selected in accordance with the intended use, and a suitably synthesized water-soluble polyester may be used, or a commercially available product may be used. Examples of the water-soluble polymer include polyvinyl alcohol, carboxy-modified polyvinyl alcohol, carboxy methyl cellulose, hydroxy ethyl cellulose, cellulose sulfate, polyethylene oxide, gelatin, cationic starch, casein, sodium polyacrylate, sodium of styrene-maleic acid anhydride copolymer, and sodium polystyrenesulfonate. Of these, polyethylene oxide is preferable.

Examples of commercially available products of the water soluble polymer include water soluble polyesters such as various plus coats manufactured by Gao Chemical Industries, FINETEX ES series manufactured by Dainippon Ink and Chemicals, Inc.; and water soluble acryls such as JULIMER AT series manufactured by Nihon Junyaku Co., Ltd., FINTEX 6161, K-96 manufactured by Dainippon Ink and Chemicals, Inc., and HIROS NL-1189 and BH-997L manufactured by SEIKO PMC CORPORATION.

In addition, examples of the water soluble polymer include those described on page 26 No. 643 Research Disclosure No. 17,643, on page 651 Research Disclosure No. 18,716, on pp. 873-874 Research Disclosure No. 307,105, and Japanese Patent Application Laid-Open (JP-A) No. 64-13546.

The content of the water soluble polymer in the image-receiving layer is not particularly limited and may be suitably selected in accordance with the intended use, however, it is preferably 0.5 g/m² to 2 g/m².

The image-receiving layer preferably contains the water dispersible emulsion and the water-soluble polymer, and may optionally contain other components.

The lower limit of the volume average particle diameter of the water dispersible emulsion is preferably 20 nm, and more preferably 55 nm. The upper limit is not particularly limited and may be suitably selected in accordance with the intended use, however, it is preferably 200 nm. When the volume average particle diameter of the water dispersible emulsion is less than 20 nm, cohesion easily occurs in the coating solution for image-receiving layer, which may impair film-forming performance. Here, the volume average particle diameter can be measured, for example, using COULTER MODEL N4 SD (manufactured by Coulter Electronics) after dilution of a water dispersible polyester emulsion with ion exchange water.

The mass average molecular mass (Mw) of the water-soluble polymer is 400,000 or less, and preferably 100,000 to 400,000. When the mass average molecular mass (Mw) of the water-soluble polymer is more than 400,000, cohesion easily occurs, which may cause failure in surface shape after coating.

In addition, the amount of the water-soluble polymer adsorbed in the coating solution for image-receiving layer that contains the water dispersible emulsion and the water-soluble polymer is preferably less than 2% by mass. When the adsorbed amount of the water-soluble polymer is more than 2% by mass, cohesion may occur in the coating solution for image-receiving layer that contains the water dispersible emulsion and the water-soluble polymer.

Here, the adsorbed amount of the water-soluble polymer can be determined as follows. Specifically, the water dispersible emulsion and the water-soluble polymer are mixed (water dispersible emulsion: water-soluble polymer=100:17 (mass ratio)), and the amount of water-soluble polymer (polyethylene oxide) dissolved in a supernatant after centrifugation is determined quantitatively by NMR. From the added amount of the polyethylene oxide, the adsorbed amount of the polyethylene oxide (% by mass) can be determined.

The adsorbed amount of 2% by mass to 5% by mass means that cohesion has occurred due to depletion, and the adsorbed amount of 30% by mass or more means that cohesion has occurred due to adsorption and/or crosslinking.

The mass ratio between the water dispersible emulsion and the water-soluble polymer (water dispersible emulsion: water-soluble polymer) is preferably 1:0.01 to 1:1, and more preferably 1:0.1 to 1:1.

The polymer for image-receiving layer can be used in combination with other polymer materials, however, in such a case, typically, the polymer for image-receiving layer is used in a higher content than that of the other polymer materials.

The content of the polymer for image-receiving layer in the image-receiving layer is preferably 10% by mass or more, more preferably 30% by mass or more, still more preferably 50% by mass or more, and particularly preferably 50% by mass to 90% by mass.

The image-receiving layer contains at least the fine particles and the polymer for image-receiving layer, and further contains other components in accordance with the necessity, such as various additives that can be blended to materials of the image-receiving layer in order to improve thermodynamic properties of the image-receiving layer, for example, a releasing agent, a plasticizer, a colorant, a filler, a crosslinking agent, a charge adjusting agent, an emulsifier, and a dispersing agent.

—Releasing Agent—

The releasing agent is blended to materials of the image-receiving layer to prevent offset of the image-receiving layer. The releasing agent is not particularly limited and may be suitably selected in accordance with the intended use as long as it is heated and melted at the fixing temperature to precipitate on the surface of the image-receiving layer and unevenly exist on the surface of the image-receiving layer, and then it is cooled and solidified, thereby a layer of releasing agent materials can be formed on the surface of the image-receiving layer.

Examples of the releasing agent are at least one selected from silicone compounds, fluorine compounds, and waxes.

For the releasing agent, for example, any one of compounds described in “Properties and Applications of Waxes—Revised edition” published by Saiwai Shobo, and compounds described in “Handbook of Silicones” issued by NIKKAN KOGYO SHIMBUN, LTD. can be used. It is also possible to preferably use any one of silicone compounds, fluorine compounds, and waxes used for toners described in Japanese Patent (JP-B) Nos. 2838498, and 2949558, and Japanese Patent Application Laid-Open (JP-A) Nos. 59-38581, 04-32380, 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-36210, 0743940, 07-56387, 07-56390, 07-64335, 07-199681, 07-223362, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 1144969, 11-65156, 11-73049, and 11-194542. Each of these compounds may be used alone or in combination with two or more.

Examples of the silicone compounds include silicone oils, silicone rubbers, silicone fine particles, silicone-modified resins, and reactive silicone compounds.

Examples of the silicone oils include unmodified silicone oil, amino-modified silicone oils, carboxy-modified silicone oils, carbinol-modified silicone oils, vinyl-modified silicone oils, epoxy-modified silicone oils, polyether-modified silicone oils, silanol-modified silicone oils, methacryl-modified silicone oils, mercapto-modified silicone oils, alcohol-modified silicone oils, alkyl-modified silicone oils, and fluorine-modified silicone oils.

Examples of the silicone-modified resins include olefin resin, polyester resin, vinyl resin, polyamide resin, cellulose resin, phenoxy resin, vinylchloride-vinylacetate resin, urethane resin, acrylic resin, styrene-acryl resin, or resins obtained by modifying the each of the copolymer resins thereof with silicone.

The fluorine compound is not particularly limited and may be suitably selected in accordance with the intended use, and examples thereof include fluorine oils, fluorine rubbers, fluorine-modified resins, fluorine sulfonate compounds, fluorosulfonate, fluorine acid compounds or salts thereof, and inorganic fluorides.

The waxes are broadly divided into natural waxes and synthetic waxes. For the natural waxes, at least one selected from vegetable waxes, animal waxes, mineral waxes, and petroleum waxes is preferable. Of these, vegetable waxes are particularly preferable. For the natural wax, a water-dispersible wax is particularly preferable in terms of compatibility in the case where an aqueous resin is used as the polymer for image-receiving layer.

The vegetable wax is not particularly limited and may be suitably selected from among those known in the art, and it may be a commercially available product, or may be a suitably synthesized one. Examples of the vegetable wax include carnauba wax, castor oil, rapeseed oil, soybean oil, vegetable tallow, cotton wax, rice wax, sugarcane wax, candelilla wax, Japan wax, and jojoba wax.

Examples of commercially available products of the carnauba wax include EMUSTAR-0413 manufactured by NIPPON SEIRO CO., LTD., and CELLOZOL 524 manufactured by Chukyo Oils. Examples of commercially available products of the castor oil include purified castor oils manufactured by ITOH OIL CHEMICALS CO., LTD.

Among them, a carnauba wax having a melting point of 70° C. to 95° C. is particularly preferable in terms of capability of providing image-receiving sheets for electrophotography which are excellent in antioffset properties, adhesion resistance, paper conveyability, and glossiness and can form high-quality images with hardly causing cracks.

The animal wax is not particularly limited and may be suitably selected from among those known in the art, and examples thereof include beewax, lanolin, whale wax, whale oil, and sheep wool wax.

The mineral wax is not particularly limited and may be suitably selected from among those known in the art, and it may be a commercially available product or may be a suitably synthesized one. Examples thereof include montan wax, montan-based ester wax, ozokerite, and ceresin. Of these, a montan wax having a melting point of 70° C. to 95° C. is particularly preferable in terms of capability of providing image-receiving sheets for electrophotography which are excellent in antioffset properties, adhesion resistance, paper conveyability, and glossiness and can form high-quality images with hardly causing cracks.

The petroleum wax is not particularly limited and may be suitably selected from among those known in the art, and it may be a commercially available product, or may be a suitably synthesized one. Examples of the petroleum wax include paraffin waxes, microcrystalline waxes, and petrolatum.

The content of the natural wax in the image-receiving layer is preferably 0.1 g/m² to 4 g/m², and more preferably 0.2 g/m² to 2 g/m². When the content of the natural wax is less than 0.1 g/m², antioffset property and adhesion resistance of the image-receiving sheet may be particularly insufficient. When the content of the natural wax is more than 4 g/m², the quality of an image to be formed may be degraded due to the excessive amount of the wax.

The melting point (° C.) of the natural wax is preferably 70° C. to 95° C., and more preferably 75° C. to 90° C. from the viewpoint of antioffset property and paper conveyability.

The synthesized waxes are divided into synthetic hydrocarbons, modified waxes, hydrogenated waxes, and other fat and fatty oil synthetic waxes. Among them, a water dispersible wax is preferable in terms of compatibility in the case where an aqueous thermoplastic resin is used as a thermoplastic resin for the image-receiving layer.

Examples of the synthetic hydrocarbons include Fischer-Tropsch waxes, and polyethylene waxes.

Examples of the fat and fatty oil synthetic waxes include acid amide compounds (such as stearic acid amid), and acid imide compounds (such as phthalic anhydride imide).

The modified wax is not particularly limited and may be suitably selected in accordance with the intended use, and examples thereof include amine-modified waxes, acrylic acid-modified waxes, fluorine-modified waxes, olefin-modified waxes, urethane-modified waxes, and alcohol waxes.

Examples of the hydrogenated wax is not particularly limited and may be suitably selected in accordance with the intended use, and examples thereof include hardened castor oils, castor oil derivatives, stearic acids, lauric aids, myristic acids, palmitic acids, behenyl acids, sebacic acids, undecylenic acids, heptyl acids, maleic acids, and highly maleated oils.

The melting point (° C.) of the releasing agent is preferably 70° C. to 95° C., and more preferably 75° C. to 90° C. from the viewpoint of antioffset property and paper conveyability.

As a releasing agent to be added to materials of the image-receiving layer, a derivative, an oxide, a purified product, or a mixture of the above-noted releasing agents may also be used. Each of these compounds may have a reactive substituent group.

The content of the releasing agent is preferably 0.1% by mass to 10% by mass, more preferably 0.3% by mass to 8.0% by mass, and still more preferably 0.5% by mass to 5.0% by mass based on the mass of the image-receiving layer.

When the content of the releasing agent is less than 0.1% by mass, the antioffset property and adhesion resistance of the image-receiving sheet may be insufficient. When the content of the releasing agent is more than 10% by mass, the quality of an image to be formed may be degraded due to the excessive amount of the releasing agent.

—Plasticizer—

The plasticizer is not particularly limited and may be suitably selected from among plasticizers for resin in the art in accordance with the intended use. The plasticizer has a function to control fluidization and tenderization of the image-receiving layer by the heat or pressure during fixing the toner.

Examples of a reference for selecting the plasticizer include literatures, such as “Kagaku Binran (Chemical Handbook)” (edited by The Chemical Society of Japan and published by Maruzen Co., Ltd.), “Plasticizer, Theory and Application” (edited by Koichi Murai and published by Saiwai Shobo), “Volumes 1 and 2 of Studies on Plasticizer” (edited by Polymer Chemistry Association) and “Handbook on Compounding Ingredients for Rubbers and Plastics” (edited by Rubber Digest Co.).

Some plasticizers are described as an organic solvent having a high boiling point or a thermal solvent in some literatures. Examples of the plasticizer include esters (such as phthalate esters, phosphorate esters, fatty esters, abietate esters, adipate esters, sebacate esters, azelate esters, benzoate esters, butyrate esters, epoxidized fatty esters, glycolate esters, propionate esters, trimellitate esters, citrate esters, sulfonate esters, carboxylate esters, succinate esters, malate esters, fumarate esters, phthalate esters and stearate esters); amides (such as fatty amides and sulfonate amides); ethers; alcohols; lactones and polyethylene oxides, which are described in patent documents, such as JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 02-235694.

These plasticizers may be incorporated in the composition of the resin.

Further, a plasticizer having a relatively low molecular mass can be also used. The plasticizer has a molecular mass which is preferably lower than that of a binder resin which is plasticized by the plasticizer and preferably 15,000 or less, more preferably 5,000 or less. In addition, when a plasticizer is a polymer, the plasticizer is preferably the same polymer as that of the binder resin which is plasticized by the plasticizer. For example, for plasticizing a polyester resin, the plasticizer is preferably a polyester having a low molecular mass. Further, an oligomer can be also used as a plasticizer.

Besides the above-noted compounds, examples of the plasticizer which is commercially available include ADEKACIZER PN-170 and PN-1430 (manufactured by Asahi Denka Kogyo Co., Ltd.); PARAPLEX G-25, G-30 and G40 (manufactured by C. P. Hall Co., Ltd.); and ESTER GUM 8L-JA, ESTER R-95, PENTALIN 4851, FK 115,4820,830, LUISOL 28-JA, PICOLASTIC A75, PICOTEX LC and CRYSTALEX 3085 (manufactured by Rika Hercules Co., Ltd.).

The plasticizer may be optionally used for relaxing the stress and strain (i.e., a physical strain, such as a strain in elastic force and viscosity and a strain due to a material balance in the molecule and the main chain and pendant moiety of the binder) which are caused when the toner particles are embedded in the image-receiving layer.

In the image-receiving layer, the plasticizer may be finely (microscopically) dispersed, may be in the state of a fine phase-separation in a sea-island structure and may be combined with other components, such as a binder resin.

The content of the plasticizer in the image-receiving layer is preferably 0.001% by mass to 90% by mass, more preferably 0.1% by mass to 60% by mass, still more preferably 1% by mass to 40% by mass, based on the mass of the image-receiving layer.

The plasticizer may be used for controlling slip properties (for improving the conveyability by reducing the friction), improving the offset of the toner at the fixing part of the fixing apparatus (peeling of the toner or the image-receiving layer to the fixing part) and controlling the curling balance and electrostatic charge (formation of a toner electrostatic image).

—Colorant—

The colorant is not particularly limited and may be suitably selected in accordance with the intended use. Examples of the colorant include a fluorescent whitening agent, a colored pigment and a dye.

The fluorescent whitening agent is not particularly limited as long as the agent is a compound having the absorption in the near-ultraviolet region and emitting a fluorescence having a wavelength of 400 nm to 500 nm and may be suitably selected from among conventional fluorescent whitening agents. Preferred examples of the fluorescent whitening agent include the compounds described in the literature “The Chemistry of Synthetic Dyes, Volume V” (edited by K. Veen Rataraman, Chapter 8). The fluorescent whitening agent may be a commercially available product or a suitably synthesized product. Examples of the fluorescent whitening agent include stilbene compounds, coumarin compounds, biphenyl compounds, benzo-oxazoline compounds, naphthalimide compounds, pyrazoline compounds and carbostyril compounds. Examples of the commercially available fluorescent whitening agent include white FURFAR-PSN, PHR, HCS, PCS and B (manufactured by Sumitomo Chemicals Co., Ltd.) and UVITEX-OB (manufactured by Ciba-Geigy Corp.).

The colored pigment is not particularly limited and may be suitably selected from among conventional colored pigments. Examples of the colored pigment include various pigments described in JP-A No. 63-44653, such as an azo pigment, a polycyclic pigment, a condensed polycyclic pigment, a lake pigment and a carbon black.

Examples of the azo pigment include an azo lake pigment (such as carmine 6B and red 2B), an insoluble azo pigment (such as monoazo yellow, disazo yellow, pyrazolone orange and Vulcan orange) and a condensed azo pigment (such as chromophthal yellow and chromophthal red).

Examples of the polycyclic pigment include a phthalocyanine pigment, such as copper phthalocyanine blue and copper phthalocyanine green.

Examples of the condensed polycyclic pigment include a dioxazine pigment (such as dioxazine violet), an isoindolinone pigment (such as isoindolinone yellow), a threne pigment, a perylene pigment, a perinone pigment and a thioindigo pigment.

Examples of the lake pigment include malachite green, rhodamine B, rhodamine G and Victoria blue B.

Examples of the inorganic pigment include an oxide (such as titanium dioxide and iron oxide red), a sulfate salt ( such as precipitated barium sulfate), a carbonate salt (such as precipitated calcium carbonate) a silicate salt (such as a hydrous silicate salt and an anhydrous silicate salt) and a metal powder (such as aluminum powder, bronze powder, zinc powder, chrome yellow and iron blue).

Each of these pigments may be used alone or in combination with two or more.

The dye is not particularly limited and may be suitably selected from among conventional dyes depending on the application. Examples of the dye include anthraquinone compounds and azo compounds. These dyes may be used alone or in combination.

Examples of the water-insoluble dye include a vat dye, a disperse dye and an oil-soluble dye. Specific examples of the vat dye include C.I. Vat violet 1, C.I. Vat violet 2, C.I. Vat violet 9, C.I. Vat violet 13, C.I. Vat violet 21, C.I. Vat blue 1, C.I. Vat blue 3, C.I. Vat blue 4, C.I. Vat blue 6, C.I. Vat blue 14, C.I. Vat blue 20 and C.I. Vat blue 35. Specific examples of the disperse dye include C.I. disperse violet 1, C.I. disperse violet 4, C.I. disperse violet 10, C.I. disperse blue 3, C.I. disperse blue 7 and C.I. disperse blue 58. Specific examples of the oil-soluble dye include C.I. solvent violet 13, C.I. solvent violet 14, C.I. solvent violet 21, C.I. solvent violet 27, C.I. solvent blue 11, C.I. solvent blue 12, C.I. solvent blue 25 and C.I. solvent blue 55.

Colored couplers used in the silver halide photography may also be used preferably as the dye.

The content of the colorant in the image-receiving layer is preferably 0.1 g/m²to 8 g/m², and more preferably 0.5 g/m²to 5 g/m².

When the content of the colorant is less than 0.1 g/m², the light transmittance of the image-receiving layer may be high. In contrast, when the amount is more than 8 g/m², handling properties, such as crazing and adhesion resistance may be impaired.

Examples of the filler include an organic filler and an inorganic filler which is a reinforcing agent for the binder resin or a conventional filler as a reinforcer or a bulking agent. The filler may be properly selected by referring to “Handbook of Rubber and Plastics Additives” (edited by Rubber Digest Co.), “Plastics Blending Agents—Basics and Applications” (New Edition) (published by Taisei Co.) and “The Filler Handbook” (published by Taisei Co.).

Examples of the filler include an inorganic filler and an inorganic pigment. Specific examples of the inorganic filler or the inorganic pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among them, silica and alumina are most preferred. Each of these fillers may be used alone or in combination with two or more. It is preferred that the filler has a small particle diameter. When the filler has a large particle diameter, the surface of the image-receiving layer is easily roughened.

Examples of the silica include a spherical silica and an amorphous silica. The silica can be synthesized by a dry method, a wet method or an aerogel method. The silica may be also produced by treating the surface of the hydrophobic silica particles with a trimethylsilyl group or silicone. Preferred examples of the silica include a colloidal silica. The silica is preferably porous.

Examples of the alumina include an anhydrous alumina and a hydrated alumina. Examples of the crystallized anhydrous alumina include α-, β-, γ-, δ-, ξ-, η-, θ-, κ-, ρ- and χ-anhydrous alumina. The hydrated alumina is more preferred than the anhydrous alumina. Examples of the hydrated alumina include a monohydrated alumina and a trihydrate alumina. Examples of the monohydrated alumina include pseudo-boehmite, boehmite and diaspore. Examples of the trihydrated alumina include gibbsite and bayerite. The alumina is preferably porous.

The hydrated alumina can be synthesized by the sol-gel method in which ammonia is added to a solution of an aluminum salt to precipitate alumina or by a method of hydrolyzing an alkali aluminate. The anhydrous alumina can be obtained by heating to dehydrate a hydrated alumina.

The content of the filler is preferably 5 parts by mass to 2,000 parts by mass, relative to 100 parts by mass (in terms of dry mass) of the binder resin in the image-receiving layer.

The crosslinking agent may be blended to materials of the image-receiving layer for controlling the shelf stability and thermoplasticity of the image-receiving layer. Examples of the crosslinking agent include a compound containing in the molecule two or more reactive groups selected from the group consisting of an epoxy group, an isocyanate group, an aldehyde group, an active halogen group, an active methylene group, an acetylene group and other conventional reactive groups.

Examples of the crosslinking agent include also a compound containing in the molecule two or more groups which can form a bond through a hydrogen bond, an ionic bond or a coordination bond.

Specific examples of the crosslinking agent include a compound which is conventional as a coupling agent, a curing agent, a polymerizing agent, a polymerization promoter, a coagulant, a film-forming agent or a film-forming assistant which is used for the resin. Examples of the coupling agent include chlorosilanes, vinylsilanes, epoxisilanes, aminosilanes, alkoxy aluminum chelates, titanate coupling agents and other conventional crosslinking agents described in the literature “Handbook of Rubber and Plastics Additives” (edited by Rubber Digest Co.).

The image-receiving layer preferably contains a charge control agent for controlling the transfer and adhesion of the toner and for preventing the adhesion of the image-receiving layer due to the charge.

The charge control agent is not particularly limited and may be suitably selected from among conventional various charge control agents depending on the application. Examples of the charge control agent include a surfactant, such as a cationic surfactant, an anionic surfactant, an amphoteric surfactant and a non-ionic surfactant; a polymer electrolyte and a conductive metal oxide. Specific examples of the charge control agent include a cationic antistatic agent, such as a quaternary ammonium salt, a polyamine derivative, a cation-modified polymethyl methacrylate, a cation-modified polystyrene; an anionic antistatic agent, such as an alkyl phosphate and an anionic polymer; and a non-ionic antistatic agent, such as a fatty ester and a polyethylene oxide.

When the toner is negatively charged, the charge control agent in the image-receiving layer is preferably a cationic or nonionic charge control agent.

Examples of the conductive metal oxide include ZnO, TiO₂, SnO₂, Al₂O₃, In₂O₃, SiO₂, MgO, BaO and MoO₃. These conductive metal oxides may be used alone or in combination. The conductive metal oxide may contain (be doped with) another different element, for example, ZnO may contain (be doped with) Al and In; TiO₂ may contain (be doped with) Nb and Ta; and SnO₂ may contain (be doped with) Sb, Nb and a halogen element.

—Other Additives—

The image-receiving layer may also contain various additives for improving the stability of the output image or the stability of the image-receiving layer itself. Examples of the additives include various conventional antioxidants, anti-aging agents, deterioration inhibitors, ozone-deterioration inhibitors, ultraviolet ray absorbers, metal complexes, light stabilizers, antiseptic agents and anti-fungus agents.

The antioxidant is not particularly limited and may be suitably selected in accordance with the intended use. Examples of the antioxidant include a chroman compound, a coumarin compound, a phenol compound (e.g., a hindered phenol), a hydroquinone derivative, a hindered amine derivative and a spiroindane compound. With respect to the antioxidant, there is a description in JP-A No. 61-159644.

The anti-aging agent is not particularly limited and may be suitably selected in accordance with the intended use. Examples of the anti-aging agent include anti-aging agents described in the literature “Handbook on Compounding Ingredients for Rubbers and Plastics, revised second edition” (published by Rubber Digest Co., 1993, pp. 76-121).

The ultraviolet ray absorber is not particularly limited and may be suitably selected in accordance with the intended use. Examples of the ultraviolet ray absorber include a benzotriazol compound (see U.S. Pat. No. 3,533,794), a 4-thiazolidone compound (see U.S. Pat. No. 3,352,681), a benzophenone compound (see JP-A No. 46-2784) and an ultraviolet ray absorbing polymer (see JP-A No. 62-260152).

The metal complex is not particularly limited and may be suitably selected in accordance with the intended use. Proper examples of the metal complex include metal complexes described in patent documents, such as U.S. Pat. Nos. 4,241,155, 4,245,018, and 4,254,195; and JP-A Nos. 61-88256, 62-174741, 63-199248, 01-75568 and 01-74272.

Also, preferred examples of the ultraviolet ray absorber or the light stabilizer include ultraviolet ray absorbers or light stabilizers described in the literature “Handbook on Compounding Ingredients for Rubbers and Plastics, revised second edition” (published by Rubber Digest Co., 1993, pp. 122-137).

The image-receiving layer may optionally comprise the above-noted conventional additives for photography. Examples of the additive for photography include additives described in the literatures “Journal of Research Disclosure (hereinafter referred to as RD) No. 17643 (December, 1978), No. 18716 (November, 1979) and No. 307105 (November, 1989)”. These additives are specifically noted with respect to the pages of the Journal RD which are to be referred to a table as shown in the following Table 1.

TABLE 1

| | Pages of Journal RD | | |
|---|---|---|---|
| Type of additives | RD17643 | RD18716 | RD307105 |
| Whitening agent | pp. 24 | p. 648 right column | pp. 868 |
| Stabilizer | pp. 24-25 | p. 649 right column | pp. 868-870 |
| Light absorber | pp. 25-26 | p. 649 right column | pp. 873 |
| (Ultraviolet ray | | | |
| Dye image stabilizer | pp. 25 | p. 650 right column | pp. 872 |
| Film hardener | pp. 26 | p. 651 left column | pp. 874-875 |
| Binder | pp. 26 | p. 651 left column | pp. 873-874 |
| Plasticizer, lubricant | pp. 27 | p. 650 right column | pp. 876 |
| Auxiliary coating agent | pp. 26-27 | p. 650 right column | pp. 875-876 |
| (Surfactant) | | | |
| Antistatic agent | pp. 27 | p. 650 right column | pp. 876-877 |
| Matting agent | — | — | pp. 878-879 |

The image-receiving layer is disposed on the support by coating the support with the coating solution containing a thermoplastic resin used for producing the image-receiving layer using a wire coater and by drying the resultant coating. The Minimum Film Forming Temperature (MFT) of the thermoplastic resin used in the present invention is preferably room temperature or higher during the storage of the image-receiving sheet before the printing and preferably 100° C. or lower during the fixing of the toner particles.

The mass of the dried coating as the image-receiving layer is preferably from 1 g/m² to 20 g/m², more preferably from 4 g/m² to 15 g/m².

The thickness of the image-receiving layer is not particularly limited and may be suitably selected in accordance with the intended use. The thickness is preferably ½ or more of the diameter of the toner particles, more preferably from 1 time to 3 times the diameter of the toner particles. More specifically, the thickness is preferably from 1 μm to 50 μm, more preferably from 1 μm to 30 μm, still more preferably from 2 μm to 20 μm, most preferably from 5 μm to 15 μm.

[Physical Properties of Image-Receiving Layer]

The 180-degree peel strength of the image-receiving layer at the temperature for the image-fixing at which the image is fixed on the fixing member is preferably 0.1 N/25 mm or less, more preferably 0.041 N/25 mm or less. The 180-degree peel strength can be measured according to the method described in JIS K 6887 using a surface material of the fixing member.

It is preferred that the image-receiving layer has high glossiness after the image forming. With respect to the gloss level of the image-receiving layer, through the range of from the state in which the image-receiving layer is white (i.e., there is no toner in the image-receiving layer) to the state in which the image-receiving layer is black (i.e., there is full of the toner in the image-receiving layer), the 45-degree gloss level of the image-receiving layer is preferably 60 or more, more preferably 75 or more, still more preferably 90 or more. However, the gloss level of the image-receiving layer is preferably 110 or less. When the gloss level is more than 110, the image has a metallic luster and such a quality of the image is undesirable. The gloss level can be measured according to JIS Z 8741.

It is preferred that the image-receiving layer has high smoothness after the fixing. With respect to the smoothness of the image-receiving layer, through the range of from the state in which the image-receiving layer is white (i.e., there is no toner in the image-receiving layer) to the state in which the image-receiving layer is black (i.e., there is full of the toner in the image-receiving layer), the arithmetic average roughness (Ra) of the image-receiving layer is preferably 3 μm or less, more preferably 1 μm or less, still more preferably 0.5 μm or less.

The arithmetic average roughness can be measured, for example, according to the methods described in JIS B 0601, B 0651 and B 0652.

The image-receiving layer has preferably one of the physical properties described in the following items (1) to (6), more preferably several of them, most preferably all of them.
(1) The melt temperature (Tm) of the image-receiving layer is preferably 30 ° C. or higher, more preferably a temperature which is higher than Tₘ of the toner by 20° C., or lower.
(2) The temperature at which the viscosity of the image-receiving layer is 1×10⁵ cp is preferably 40° C. or higher, more preferably a temperature which is lower than the temperature at which the viscosity of the toner is 1×10⁵ cp.
(3) The storage elasticity modulus (G′) of the image-receiving layer at the temperature for the image-fixing is preferably from 1×10² Pa to 1×10⁵ Pa and the loss elasticity modulus (G″) of the image-receiving layer at the temperature for the image-fixing is preferably from 1×10² Pa to 1×10⁵ Pa.
(4) The loss tangent (G″/G′) of the image-receiving layer at the fixing temperature is preferably from 0.01 to 10, wherein the loss tangent is the ratio of the loss elasticity modulus (G″) to the storage elasticity modulus (G′).
(5) The storage elasticity modulus (G′) of the image-receiving layer at the fixing temperature differs from the storage elasticity modulus (G′) of the toner at the fixing temperature, preferably by −50 to +2,500.
(6) The inclination angle of the molten toner on the image-receiving layer is preferably 50° or less, more preferably 40° or less.

The image-receiving layer preferably satisfies the physical properties described in Japanese Patent No. 2788358 and JP-A Nos. 07-248637, 08-305067 and 10-239889.

The surface electrical resistance of the image-receiving layer is preferably in the range of from 1×10⁶ Ω/cm² to 1×10¹⁵ Ω/cm² (under conditions of 25° C. and 65% RH).

When the surface electrical resistance is less than 1×10⁶ Ω/cm², the amount of the toner transferred to the image-receiving layer is unsatisfactory, and thus a disadvantage is caused wherein the density of the obtained toner image becomes easily too low. In contrast, when the surface electrical resistance is more than 1×10¹⁵ Ω/cm², more charge than the necessity is generated in the image-receiving layer during the transfer, and thus disadvantages are caused wherein the toner is transferred so unsatisfactorily that the density of the obtained image is low and the image-receiving sheet for electrophotography is electrostatically charged, so that the image-receiving sheet adsorbs easily the dust. Moreover, in this case, miss feed, multi feed, discharge marks and toner transfer dropout may occur during the copying.

The surface electrical resistance of the image-receiving layer can be measured according to the method described in JIS K 6911 as follows. The sample of the image-receiving layer is left under the condition where the temperature is 20° C. and the humidity is 65% for 8 hours or more and after applying a voltage of 100 V to the sample of the image-receiving layer for 1 minute under the same condition as the above-noted condition, the surface electrical resistance of the image-receiving layer can be measured using a micro-ammeter R8340 (manufactured by Advantest Ltd.).

[Other Layers]

Examples of the other layers which the image-receiving sheet for electrophotography contains include, a back layer, a surface-protecting layer, an adhesion-improving layer, an intermediate layer, a cushion layer, a charge-controlling (preventing) layer, a reflective layer, a tint-controlling layer, a shelf stability-improving layer, an anti-adhesion layer, an anti-curling layer and a smoothing layer. These layers may be in a single layer structure or a laminated structure of plural layers.

—Back Layer—

The back layer in the image-receiving sheet for electrophotography is preferably disposed on a surface of the support, which is opposite to another surface of the support on which the image-receiving layer is disposed, for imparting back side-output suitability to the image-receiving sheet and improving the image quality of the back side-output, curling balance and conveyability of the image-receiving sheet.

The color of the back layer is not particularly limited, however, when the image-receiving sheet for electrophotography is an image-receiving sheet of the both-side output type forming an image also on the back side thereof, preferably, the color of the back layer is also white. The back layer has preferably whiteness of 85% or more and spectral reflectance of 85% or more, like the image-receiving layer.

Moreover, for improving both-side output suitability, the back layer may have a composition same as that of the front side of the sheet, which contains the image-receiving layer. The back layer may contain besides the above-noted particles, the above-explained various additives. It is appropriate that as the additives, particularly a matting agent and a charge control agent are used. The back layer may have a single-layer structure or a laminated structure of two or more layers.

When for preventing the offset during the image-fixing, an oil having release properties is applied to the fixing roller, the back layer may have oil absorbency.

Usually, the thickness of the back layer is preferably 0.1 μm to 10 μm.

—Surface Protective Layer—

The surface protective layer may be disposed on the surface of the image-receiving layer for protecting the surface of the image-receiving sheet for electrophotography, improving shelf stability, handling properties and conveyability thereof, and imparting writing properties and anti-offset properties thereto. The surface protective layer may have a single-layer structure or a laminated structure of two or more layers. The surface protective layer may contain as a binder resin at least one of various thermoplastic resins and thermosetting resins which is preferably a resin of the same type as that of a resin used for the image-receiving layer. In this case, however, a resin used for the surface protective layer needs not to have the same thermodynamic properties or electrostatic properties as those of a resin used for the image-receiving layer and those properties of the surface protective layer can be respectively optimized.

The surface protective layer may contain the above-noted various additives which can be used for producing the image-receiving layer. Particularly, the surface protective layer may contain together with the above-noted releasing agent used in the present invention, other additives such as a matting agent. Examples of the matting agent include various conventional matting agents.

The outermost surface layer of the image-receiving sheet for electrophotography (e.g., the surface protective layer when it is disposed) has preferably good compatibility with the toner from the viewpoint of good fixability of the toner image. More specifically, the outermost surface layer has preferably a contact angle with the molten toner of from 0° to 40°.

—Adhesion-Improving Layer—

The adhesion-improving layer in the image-receiving sheet for electrophotography is preferably disposed for improving adhesion between the support and the image-receiving layer. The adhesion-improving layer may contain the above-noted various additives, particularly preferably the crosslinking agent. Further, it is preferred that in the image-receiving sheet for electrophotography according to the present invention, for improving the toner receptivity, a cushion layer is disposed between the adhesion improving layer and the image-receiving layer.

—Intermediate Layer—

The intermediate layer may be formed, for example, between the support and the adhesion-improving layer, between the adhesion-improving layer and the cushion layer, between the cushion layer and the image-receiving layer, or between the image-receiving layer and the shelf stability improving layer. When the image-receiving sheet for electrophotography contains the support, the image-receiving layer and the intermediate layer, the intermediate layer may be disposed, for example, between the support and the image-receiving layer.

The thickness of the image-receiving sheet for electrophotography according to the present invention is not particularly limited and may be suitably selected in accordance with the intended use. The thickness is preferably from 50 μm to 550 μm, and more preferably from 100 μm to 350 μm.

<Toner>

The image-receiving sheet for electrophotography according to the present invention is used by causing the image-receiving layer to receive the toner during the printing and copying.

The toner contains at least a binder resin and a colorant, and further contains a releasing agent and other components in accordance with the necessity.

—Binder Resin for Toner—

The binder resin is not particularly limited and may be suitably selected from resins used usually for producing the toner in accordance with the intended use. Examples of the binder resin include homo-polymers or copolymers produced by polymerizing or copolymerizing a vinyl monomer or two or more vinyl monomers selected from the group consisting of vinyl monomers, such as styrenes, such as styrene and parachlorostyrene; vinyl esters, such as vinyl naphthalene, vinyl chloride, vinyl bromide, vinyl fluoride, vinyl acetate, vinyl propioniate, vinyl benzoate and vinyl butyrate; methylene fatty carboxylate esters, such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; vinyl nitriles, such as acrylonitrile, methacrylonitrile and acrylamide; vinyl ethers, such as vinyl methyl ether, vinyl ethyl ether and vinyl isobutyl ether; N-vinyl compounds, such as N-vinyl pyrrole, N-vinyl carbazole, N-vinyl indole and N-vinyl pyrrolidone; and vinyl carboxylic acids, such as methacrylic acid, acrylic acid and cinnamic acid. Examples of the binder resin include also various polyesters. The above-noted examples of the binder resin may be used in combination with various waxes.

Among these resins, a resin of the same type as that of the resin used for producing the image-receiving layer according to the present invention is preferably used.

—Colorant for Toner—

The colorant used for the toner is not particularly limited and may be suitably selected from colorants used usually for producing the toner in accordance with the intended use. Examples of the colorant include various pigments, such as carbon black, chrome yellow, hansa yellow, benzidine yellow, threne yellow, quinoline yellow, Permanent Orange GTR, Pyrazolone orange, vulcan orange, watchung red, permanent red, Brilliant Carmine 3B, Brilliant Carmine 6B, Du Pont Oil Red, Pyrazolone Red, Lithol Red, Rhodamine B lake, Lake Red C, Rose Bengal, aniline blue, ultramarine blue, chalco oil blue, methylene blue chloride, phthalocyanine blue, phthalocyanine green, and malachite green oxalate; and various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes and thiazole dyes.

Each of these colorants may be used alone or in combination with two or more.

The content of the colorant is not particularly limited and may be suitably selected in accordance with the intended use. The content is preferably from 2% by mass to 8% by mass, based on the mass of the toner. When the content of the colorant is less than 2% by mass, the coloring power of the toner may be weakened. In contrast, when the content is more than 8% by mass, the clarity of the toner may be impaired.

—Releasing Agent for Toner—

The releasing agent used for the toner is not particularly limited and may be suitably selected from releasing agents used usually for the toner in accordance with the intended use. Particularly effective examples of the releasing agent include a highly crystalline polyethylene wax having a relatively low molecular mass, a Fischer-Tropsch wax, amide wax and a polar wax containing nitrogen, such as a compound having a urethane bond.

The polyethylene wax has a molecular mass of preferably 1,000 or less, and more preferably from 300 to 1,000.

The compound having a urethane bond is preferred in that even if the compound has a low molecular mass, the compound can maintain a solid state by a strong cohesive force of a polar group and such a compound having a high melting point for the molecular mass thereof can be produced. The compound has a molecular mass of preferably from 300 to 1,000. Examples of a combination of materials for producing the compound having a urethane bond include a combination of a diisocyanic acid compound and a monohydric alcohol, a combination of a monoisocyanic acid compound and a monohydric alcohol, a combination of a dihydric alcohol and a monoisocyanic acid compound, a combination of a trihydric alcohol and a monoisocyanic acid compound and a combination of a triisocyanic acid compound and a monohydric alcohol.

However, for preventing the molecular mass of the compound from becoming too large, a combination of a compound having a multiple functional group and another compound having a single functional group is preferred and it is important that, the total amount of the functionality in a combination is always equivalent.

Examples of the monoisocyanic acid compound include dodecyl isocyanate, phenyl isocyanate (and derivatives thereof), naphthyl isocyanate, hexyl isocyanate, benzyl isocyanate, butyl isocyanate and allyl isocyanate.

Examples of the diisocyanic acid compound include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate and isophorone diisocyanate.

Examples of the monohydric alcohol include methanol, ethanol, propanol, butanol, pentanol, hexanol and heptanol.

Examples of the dihydric alcohol include various glycols, such as ethylene glycol, diethylene glycol, triethylene glycol and trimethylene glycol. Examples of the trihydric alcohol include trimethylol propane, triethylol propane and trimethanol ethane.

Each of these urethane compounds may be mixed with a resin or a colorant during the kneading like a usual releasing agent to be used as a kneaded-ground type toner. When these urethane compounds are used for producing the toner produced according to the emulsion polymerization-cohesion and melting method, an aqueous dispersion of the releasing agent particles having a size of 1 μm or less is prepared according to a method including dispersing in water the urethane compound together with an ionic surfactant and a polymeric electrolyte, such as a polymeric acid and a polymeric base, thereby obtaining a dispersion of a releasing agent, heating the obtained dispersion to the melting point of the urethane compound or higher, and grinding the urethane compound until the urethane compound becomes in the form of fine particles by subjecting the above-noted dispersion to a strong shearing force using a homogenizer or a dispersing apparatus of a pressure discharge type, and the prepared dispersion of fine particles of the releasing agent is used in combination with a dispersion of resin particles and a dispersion of colorant particles to produce the toner produced according to the emulsion polymerization-cohesive melting method.

—Other Components for Toner—

The toner may contain other components such as an inner additive, a charge control agent and inorganic fine particles. Examples of the inner additive include a magnetic material, for example, a metal such as ferrite, magnetite, reduced iron, cobalt, nickel and manganese; an alloy thereof; and a compound containing these metals.

Examples of the charge control agent include various charge control agents used usually such as a quaternary ammonium salt, a nigrosine compound, a dye containing a complex of a metal (such as aluminum, iron and chromium) and a triphenylmethane pigment. It is preferred that the charge control agent is difficultly dissolved in water, from the view point of suppressing the ion strength in the toner, which may affect the stability of the charge control agent during the cohesion and the melting and reducing the pollution by the waste water.

Examples of the inorganic fine particles include all usual external additives of the toner surface, such as silica, alumina, titania, calcium carbonate, magnesium carbonate and tricalcium phosphate. These particles are preferably used in the form of a dispersion produced by dispersing the particles in an ionic surfactant, a polymer acid or a polymer base.

Further, the toner may contain as an additive a surfactant for the emulsion polymerization, the seed emulsion polymerization, the pigment dispersion, the resin particles dispersion, the releasing agent dispersion, the cohesion and stabilization thereof. Examples of the surfactant include an anionic surfactant, such as a sulfate ester surfactant, a sulfonate ester surfactant, a phosphate ester surfactant and a soap; a cationic surfactant such as an amine salt surfactant and a quaternary ammonium salt surfactant. It is also effective that the above-exemplified surfactants are used in combination with a nonionic surfactant such as a polyethylene glycol surfactant, an alkylphenol ethylene oxide adduct surfactant and a polyhydric alcohol surfactant. As a dispersing unit for dispersing the surfactant in the toner, a general unit such as a rotary shearing type homogenizer; and a ball mill, a sand mill and DYNO mill, all of which contain the media can be used.

The toner may contain optionally an external additive. Examples of the external additive include inorganic particles and organic particles. Examples of the inorganic particles include particles of SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, A₂O₃.2SiO₂, CaCO₃, MgCO₃, BaSO₄ and MgSO₄. Examples of the organic particles include particles of a fatty acid and derivatives thereof; a metal salt of the above-noted fatty acid and derivatives thereof; and a resin such as a fluorine resin, a polyethylene resin, and an acrylic resin. The average particle diameter of the above-noted particles is preferably from 0.01 μm to 5 μm, more preferably from 0.1 μm to 2 μm.

The method for producing the toner is not particularly limited and may be suitably selected in accordance with the intended use. However, it is preferred that the toner is produced according to a production method of the toner including, (i) preparing a dispersion of cohesive particles of a resin by forming cohesive particles in a dispersion of resin particles, (ii) forming attached particles by mixing the above-prepared dispersion of cohesive particles with a dispersion of fine particles so that the fine particles attach to the cohesive particles, thereby forming attached particles and (iii) forming toner particles by heating the attached particles to melt the attached particles.

—Physical Properties of Toner—

The toner has a volume average particle diameter of preferably from 0.5 μm to 10 μm.

When the volume average particle diameter of the toner is too small, handling properties of the toner (such as replenish properties, cleaning properties and fluidity) may be affected adversely and the productivity of the particles may be lowered. In contrast, when the volume average particle diameter of the toner is too large, the quality and resolution of the image due to graininess and transferability may be affected adversely.

It is preferred that the toner satisfies the above-noted range of a volume average particle diameter and has a distribution index of the volume average particle diameter (GSDv) of 1.3 or less.

The ratio (GSDv/GSDn) of the distribution index of the volume average particle diameter (GSDv) to the distribution index of the number average particle diameter (GSDn) is preferably 0.95 or more.

It is preferred that the toner satisfies the above-noted range of the volume average particle diameter and has an average (1.00 to 1.50) of the shape factor calculated according to the following equation:
Shape factor=(π×L²)/(4×S)
wherein L represents the maximum length of the toner particles and S represents the projected area of the toner particles.

When the toner satisfies the above-noted conditions, an effect on the image quality, such as graininess and resolution particularly can be obtained and moreover, dropout or blur which may accompany with the transfer is difficultly caused. Further, in this case, the handling properties of the toner may be difficultly affected adversely, even if the average particle diameter of the toner is not small.

From the viewpoint of improving the image quality and preventing the offset during the image-fixing, it is appropriate that the toner has storage elasticity modulus G′ (as measured at an angular frequency of 10 rad/sec) of 1×102 Pa to 1×10⁵ Pa at 150° C.

(Image Forming Process)

The process of forming an image of the present invention includes forming the toner image and fixing the image and smoothing the image surface, and includes other steps in accordance with the necessity.

—Formation of Toner Image—

The forming of the toner image is a step that forms a toner image on an image-receiving sheet for electrophotography of the present invention

The forming of the toner image is not particularly limited so long as by the forming, the toner image can be formed in the image-receiving sheet for electrophotography and may be suitably selected in accordance with the intended use. Examples of the forming of the toner image include a usual method used for the electrophotography such as a direct transfer method in which the toner image formed on the developing roller is directly transferred to the image-receiving sheet for eletrophotography; or an intermediate transfer belt method in which the toner image formed on the developing roller is primary-transferred to the intermediate transfer belt and the primary-transferred image is transferred to the image-receiving sheet for electrophotography. Among them, from the viewpoint of environmental stability and enhancing the image quality, the intermediate transfer belt method is preferably used.

—Fixing the Image and Smoothing the Image Surface—

The fixing the toner image and smoothing the surface of the toner image is a step in which the surface of the toner image which has been formed by the forming of the toner image is smoothened. The fixing the toner image and smoothing the surface of the toner image is performed by heating, pressurizing and cooling the toner image and by peeling the image-receiving sheet from the belt using an apparatus configured to fix the toner image and smooth the surface of the image, which is equipped with a heating-pressurizing unit, a belt and a cooling unit.

The apparatus configured to fix an image and smooth the image surface contains a heating-pressurizing unit, a belt, a cooling unit, a cooling-peeling part and further contains optionally other units.

The heating-pressurizing unit is not particularly limited and may be suitably selected in accordance with the intended use. Examples of the heating-pressurizing unit include a pair of heat rollers and a combination of a heat roller and a pressurizing roller.

The cooling unit is not particularly limited and may be suitably selected in accordance with the intended use. Examples of the cooling unit include a cooling unit which can blow a cool air and can control the cooling temperature, and a heat sink.

The cooling-peeling part is not particularly limited and may be suitably selected in accordance with the intended use. Examples of the cooling-peeling part include a section which is near of the tension roller where the image-receiving sheet for electrophotography is peeled from the belt by own stiffness (nerve) of the image-receiving sheet.

For contacting the toner image with a heating-pressurizing unit of the apparatus configured to fix the image and smooth the image surface, the image-receiving sheet is preferably pressurized. The method for pressurizing the image-receiving sheet is not particularly limited and may be suitably selected in accordance with the intended use; however, a nip pressure is preferably used. The nip pressure is, from the viewpoint of forming an image which is excellent in water resistance and surface smoothness and has excellent gloss, preferably from 1 kgf/cm²to 100 kgf/cm², more preferably from 5 kgf/cm²to 30 kgf/cm². The heating temperature in the heating-pressurizing unit is a temperature which is higher than the softening point of the polymer for image-receiving layer and is varied depending on the type of the polymer used for the image-receiving layer, however is usually preferably from 80° C. to 200° C. The cooling temperature in the cooling unit is preferably a temperature which is 80° C. or less at which the image-receiving layer is satisfactorily set, and more preferably from 20° C. to 80° C.

The belt contains a heat-resistant support film and a releasing layer disposed on the support film.

The material for the support film is not particularly limited and may be suitably selected in accordance with the intended use as long as the material has heat resistance. Examples of the material include polyimide (PI), polyethylene naphthalate (PEN), polyethylene terephthalate (PET), polyether ether ether ketone (PEEK), polyether sulfone (PES), poly ether imide (PEI) and poly parabanic acid (PPA).

The releasing layer preferably contains at least one selected from the group consisting of a silicone rubber, a fluorine rubber, a fluorocarbon siloxane rubber, a silicone resin, and a fluorine resin. Among them, the following aspects are preferred. Specifically, an aspect of a belt in which a fluorocarbon siloxane rubber-containing layer is disposed on the surface of the belt support; and an aspect of a belt in which a silicone rubber-containing layer is disposed on the surface of the belt, and a fluorocarbon siloxane rubber-containing layer is disposed on the surface of the silicone rubber-containing layer.

The fluorocarbon siloxane rubber has preferably in the main chain thereof at least one of a perfluoroalkyl ether group and a perfluoroalkyl group.

The fluorocarbon siloxane rubber is preferably a cured form of a fluorocarbon siloxane rubber composition containing the following components (A)-(D):
(A) a fluorocarbon polymer containing mainly a fluorocarbon siloxane represented by the following General Formula (1) and having an unsaturated fatty hydrocarbon group, (B) at least one of organopolysiloxane and fluorocarbon siloxane which have two or more ≡SiH groups in the molecule, wherein the amount of a ≡SiH group is from one to four times (in mole) the amount of the unsaturated fatty hydrocarbon group in the above-noted fluorocarbon siloxane rubber composition, (C) a filler, and (D) an effective amount of catalyst.

The fluorocarbon polymer as the component (A) contains mainly a fluorocarbon siloxane containing a recurring unit represented by the following formula (1) and contains an unsaturated fatty hydrocarbon group.

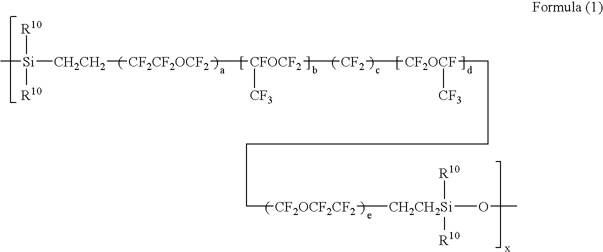

In formula (1), R¹⁰ represents an unsubstituted or substituted monovalent hydrocarbon group having 1 to 8 carbon atoms and is preferably an alkyl group having 1 to 8 carbon atoms or an alkenyl group having 2 to 3 carbon atoms, most preferably a methyl group; “a” and “e” are respectively an integer of 0 or 1, “b” and “d” are respectively an integer of 1 to 4 and “c” is an integer of 0 to 8; and “x” is preferably an integer of 1 or more, more preferably an integer of 10 to 30.

Examples of the component (A) include a compound represented by the following formula (2):

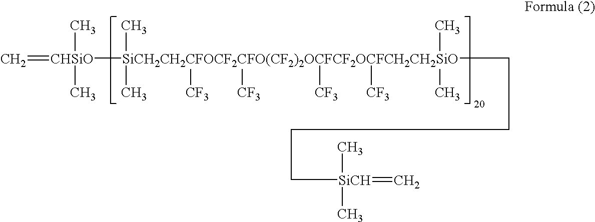

With respect to the component (B), examples of the organopolysiloxane having ≡SiH groups include an organohydrogen polysiloxane having in the molecule at least two hydrogen atoms bonded to a silicon atom.

In the fluorocarbon siloxane rubber composition, when the fluorocarbon polymer as the component (A) has an unsaturated fatty hydrocarbon group, as a curing agent, the above-noted organohydrogen polysiloxane is preferably used. In other words, the cured form is produced by an addition reaction between the unsaturated fatty hydrocarbon group of the fluorocarbon siloxane and a hydrogen atom bonded to a silicon atom in the organohydrogen polysiloxane.

Examples of the organohydrogen polysiloxane include various organohydrogen polysiloxanes used for curing a silicone rubber composition which is cured by an addition reaction.

The amount of the organohydrogen polysiloxane is an amount by which the number of ≡SiH groups in the organohydrogen polysiloxane is preferably at least one, most preferably from 1 to 5, relative to one unsaturated fatty hydrocarbon group in the fluorocarbon siloxane of the component (A).

Also, with respect to the component (B), preferred examples of the fluorocarbon siloxane having the -SiH groups include a fluorocarbon siloxane having a structure of the recurring unit represented by the formula (1), and a fluorocarbon siloxane having a structure of the recurring unit represented by the formula (1) in which R¹⁰ is a dialkylhydrogen siloxy group and the terminal group is a ≡SiH group, such as a dialkylhydrogen siloxy group or a silyl group. Such a preferred fluorocarbon siloxane can be represented by the following formula (3).

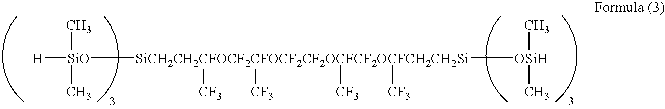

As the filler which is the component (C), various fillers used for a usual silicone rubber composition can be used. Examples of the filler include a reinforcing filler such as a mist silica, a precipitated silica, a carbon powder, titanium dioxide, aluminum oxide, a quartz powder, talc, sericite and bentonite; and a fiber filler, such as an asbesto, a glass fiber, and an organic fiber.

Examples of the catalyst as the component (D) include an element belonging to Group VIII in the Periodic Table and a compound thereof such as chloroplatinic acid; alcohol-modified chloroplatinic acid; a complex of chloroplatinic acid with an olefin; platinum black and palladium which are respectively supported on a carrier such as alumina, silica and carbon; a complex of rhodium with an olefin, chlorotris(triphenylphosphine) rhodium (Wilkinson catalyst) and rhodium (III) acetyl acetonate, which are conventional catalysts for addition reaction. It is preferred that these complexes are dissolved in a solvent, such as an alcohol compound, an ether compound or a hydrocarbon compound to be used.

The fluorocarbon siloxane rubber composition is not particularly limited and may be suitably selected in accordance with the intended use and optionally may Contain various additives. Examples of the various additives include dispersing agents such as a diphenylsilane diol, a low polymer of dimethyl polysiloxane in which the terminal of the molecule chain is blocked with a hydroxyl group, and a hexamethyl disilazane; a heat resistance improver such as ferrous oxide, ferric oxide, cerium oxide and iron octylate; and colorants such as a pigment.

The belt can be obtained by coating the surface of a heat-resistant support film with the fluorocarbon siloxane rubber composition and by curing and heating the surface of the resultant coated support film. Further optionally, the belt can be obtained by coating the surface of the support film with a coating solution prepared by diluting the fluorocarbon siloxane rubber composition with a solvent such as m-xylene hexafluoride and benzotrifluoride according to a general coating method such as spray coating, dip coating and knife coating. The heating-curing temperature and time may be properly selected from the ranges of from 100° C. to 500° C. (temperature) and from 5 seconds to 5 hours (time) depending on the type of the support film and the production method of the belt.

The thickness of the releasing layer disposed on the surface of the support film is not particularly limited and may be suitably adjusted in accordance with the intended use. For obtaining advantageous fixing properties of an image by suppressing the release properties of the toner or by preventing the offset of the toner components, the thickness is preferably from 1 μm to 200 μm, more preferably from 5 μm to 150 μm.

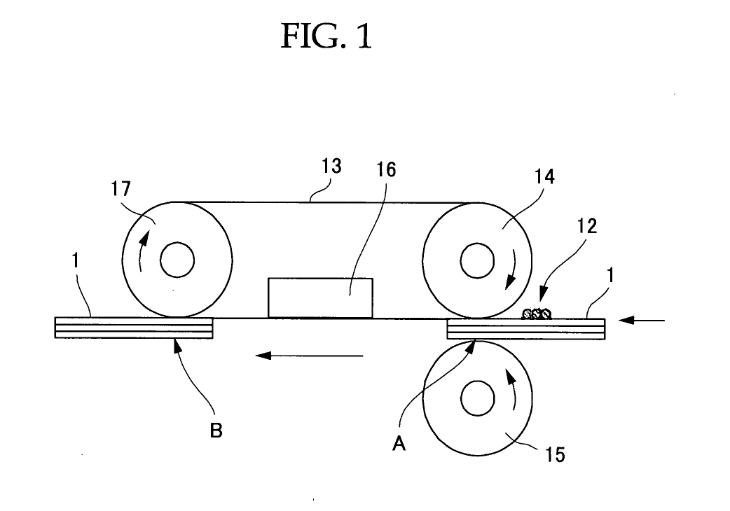

Here, with respect to an example of the belt fixing device in the image forming apparatus in the present invention, explanations are given in detail with referring to FIG. 1.

First, by an image forming apparatus (not illustrated in FIG. 1), a toner 12 is transferred to an image-receiving sheet for electrophotography 1. The image-receiving sheet for electrophotography 1 to which the toner 12 adhered is conveyed to the point A by a conveying unit (not illustrated in FIG. 1) and passes through between a heat roller 14 and a pressurizing roller 15 to be heated and pressed at the temperature (fixing temperature) and under the pressure, wherein the temperature and pressure are enough high to satisfactorily soften the image-receiving layer of the image-receiving sheet for electrophotography 1 or the toner 12.

Here, the fixing temperature means a temperature of the surface of the image-receiving layer measured in a nip space between the heat roller 14 and the pressurizing roller 15 at the point A, and for example, the fixing temperature is preferably from 80° C. to 190° C., more preferably from 100° C. to 170° C. The (fixing) pressure means a pressure of the surface of the image-receiving layer measured also in a nip space between the heat roller 14 and the pressurizing roller 15 at the point A, and for example, the fixing pressure is preferably from 1 kgf/cm² to 10 kgf/cm², more preferably from 2 kgf/cm² to 7 kgf/cm².

The thus heated and pressurized image-receiving sheet for electrophotography 1 is, next, conveyed by a fixing belt 13 to a cooling unit 16 and during the conveyance of the image-receiving sheet for electrophotography 1, in the image-receiving sheet for electrophotography 1, a releasing agent (not illustrated in FIG. 1) dispersed in the image-receiving layer is satisfactorily heated and molten. The molten releasing agent is gathered to the surface of the image-receiving layer so that in the surface of the image-receiving layer, a layer (film) of the releasing agent is formed. The image-receiving sheet for electrophotography 1 is conveyed to the cooling unit 16 by the fixing belt 13 and then cooled by the cooling unit 16 to a temperature which is, for example, not higher than either the softening point of a binder resin used for producing the image-receiving layer or the toner, or to a temperature which is lower than the glass transition point of the above-noted binder resin plus 10° C., wherein the temperature to which the image-receiving sheet for electrophotography 1 is cooled is preferably from 20° C. to 80° C., more preferably room temperature (25° C.). Thus, the layer (film) of the releasing agent formed in the surface of the image-receiving layer is cooled and set, thereby forming the release agent layer.

The cooled image-receiving sheet for electrophotography 1 is conveyed by the fixing belt 13 further to the point B and the fixing belt 13 moves along the tension roller 17. Accordingly, at the point B, the image-receiving sheet for electrophotography 1 is peeled from the fixing belt 13. It is preferred that the diameter of the tension roller 17 is so small designed that the image-receiving sheet for electrophotography 1 can be peeled from the fixing belt 13 by own stiffness (nerve) of the image-receiving sheet for electrophotography 1.

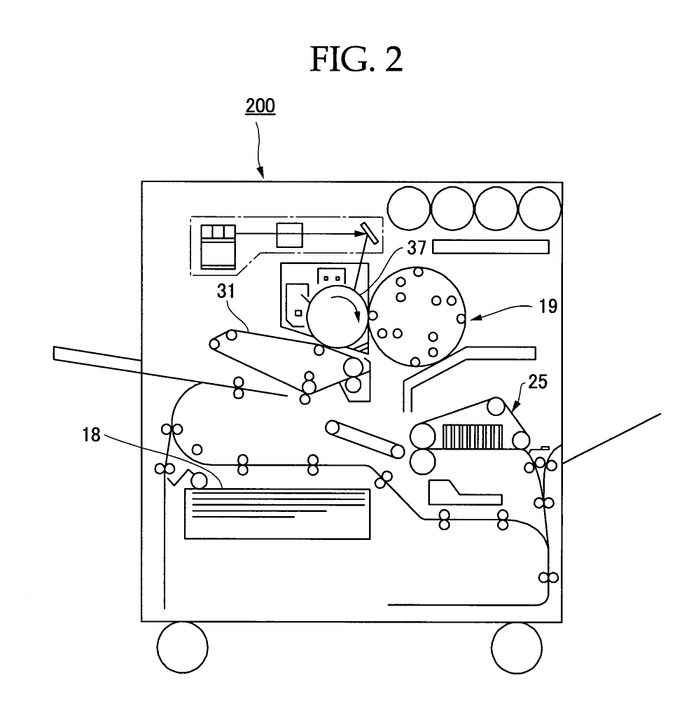

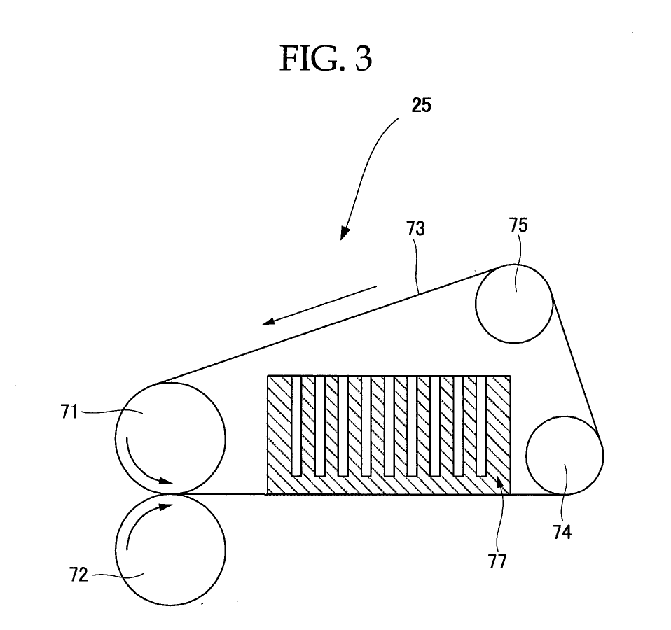

An apparatus configured to fix an image and smooth the image surface shown in FIG. 3 can be used in an image forming apparatus (e.g., a full-color laser printer DCC-500 (manufactured by Fuji Xerox Co., Ltd.)) shown in FIG. 2 by converting the image forming apparatus to a part of the belt fixing in the image forming apparatus.

As shown in FIG. 2, an image forming apparatus 200 is equipped with a photoconductive drum 37, a development device 19, an intermediate transfer belt 31, an image-receiving sheet for electrophotography 18, and a fixing unit or an apparatus configured to fix an image and smooth the image surface 25.

FIG. 3 shows the apparatus configured to fix an image and smooth the image surface 25 or the fixing unit which is arranged inside the image forming apparatus 200 in FIG. 2.

As shown in FIG. 3, the apparatus configured to fix an image and smooth the image surface 25 is equipped with a heat roller 71, a peeling roller 74, a tension roller 75, an endless belt 73 supported rotatably by the tension roller 75 and pressurizing roller 72 contacted by pressure to the heat roller 71 through the endless belt 73.

A cooling heatsink 77 which forces the endless belt 73 to cool is arranged inside the endless belt 73 between the heat roller 71 and the peeling roller 74. The cooling heatsink 77 constitutes a cooling and sheet-conveying unit for cooling and conveying the image-receiving sheet for electrophotography.

In the apparatus configured to fix an image and smooth the image surface 25 as shown in FIG. 3, the image-receiving sheet for electrophotography 18 bearing a color toner image transferred and fixed on the surface of the image-receiving sheet for electrophotography 18, is introduced into a press-contacting portion (or nip portion) between the heat roller 71 and the pressurizing roller 72 contacted by pressure to the heat roller 71 through the endless belt 73 such that the color toner image in the image-receiving sheet faces to the heat roller 71, wherein while the the image-receiving sheet for electrophotography passes through the press-contacting portion between the heat roller 71 and the pressurizing roller 72, the color toner image is heated and fused to be fixed on the the image-receiving sheet for electrophotography 18.

Thereafter, the image-receiving sheet for electrophotography bearing the color toner image fixed in the image-receiving layer of image-receiving sheet for electrophotography by heating the toner of the color toner image to a temperature of substantially from 120° C. to 130° C. at the press-contacting portion between the heat roller 71 and the pressurizing roller 72 is conveyed by the endless belt 73, while the image-receiving layer in the surface of image-receiving sheet for electrophotography adheres to the surface of the endless belt 73. During the conveyance of the image-receiving sheet for electrophotography 18, the endless belt 73 is forcedly cooled by the cooling heatsink 77 and the color toner image and the image-receiving layer are cooled and set so that the image-receiving sheet for electrophotography 18 is peeled from the endless belt 73 by the peeling roller 74 and own stiffness (nerve) of the image-receiving sheet for electrophotography 18.

The surface of the endless belt 73 after the peeling of the image-receiving sheet for electrophotography 18 is cleaned by removing a residual toner therefrom using a cleaner (not illustrated in FIG. 3) and prepared for the next step of fixing the image and smoothing the image surface.

According to the image forming process of the present invention, even if an oilless machine that does not use fixing oil is used, the release properties of the image-receiving sheet for electrophotography and the toner can be suppressed, the offset of the image-receiving sheet for electrophotography and the toner components can be prevented, and paper can be fed stably. In addition, high-quality images that have excellent surface shape and gloss level and that are close to silver halide photography prints can be formed.

The present invention can solve conventional problems and can provide a high-quality image-receiving sheet for electrophotography which is excellent in toner transferability, conveyability and whiteness of the surface of the image-receiving layer and which does not cause cracks in the image when bended, and an image forming process using the image-receiving sheet for electrophotography.

Hereafter, the present invention will be described by means of examples, but it will be understood that the invention should not be construed as being limited thereby.

### EXAMPLES

### Example 1

<Production of Image-Receiving Sheet for Electrophotography>

—Preparation of Raw Paper—

The paper materials, LBKP made of acacia prepared to Canadian Freeness of 30 ml using a disk refiner, and LBKP made of aspen prepared to Canadian Freeness 300 ml using a disk refiner were mixed with a composition of acacia 25% by mass and aspen 75% by mass, and thereby prepared the pulp slurry. The obtained pulp slurry was prepared by adding, per pulp, cationic starch (CATO 304L, manufactured by Japan NSC) 1.3% by mass, anionic polyacrylamide (polyakron ST-13, manufactured by Seiko Polymer Corporation,) 0.145% by mass, alkylketene dimer (Sizepine K, manufactured by Arakawa Chemical Industries, Ltd.,) 0.285% by mass, and polyamide-polyamine-epichlorohydrin (Arafix 100, manufactured by Arakawa Chemical Industries, Ltd.,) 0.32% by mass, and then, further adding the defoaming agent 0.12% by mass.

Next, the prepared pulp slurry was made into paper by a long-net paper-making machine, the surface of the web was pressed and dried by a drum dryer cylinder through a dryer canvas, and thereby obtained raw paper. The tensile force of the dryer canvas was fixed to 1.6 kg/cm. 1 g/m² of polyvinyl alcohol (KL-118, manufactured by Kuraray Co., Ltd.) was coated and dried on both surfaces of the obtained raw paper by a side press, and then calendar treatment was performed. In this way, raw paper with a basis weight of 163 g/m² and a thickness of 160 μm was prepared.

—Preparation of Support—

On the surface of the obtained raw paper, which is the opposite surface of the image-receiving layer being disposed, the polyethylene resin of composition shown in Table 2 was laminated by extruding in a single layer using the cooling roll of which surface roughness of matte surface was 10 μm, at melt discharge film temperature 310° C. and linear speed 250 m/min, and thereby disposed the back surface polyethylene resin layer of 22 μm thick.

TABLE 2

| | MFR | Density | Amount of additives |
|---|---|---|---|
| Composition | (g/10 min) | (g/cm³) | (% by mass) |
| HDPE | 12 | 0.967 | 55 |
| LDPE | 3.5 | 0.923 | 45 |

*HDPE: high-density polyethylene
*LDPE: low-density polyethylene

Next, on the surface of the raw paper on which the image-receiving layer was to be disposed (right face), a mixture of an LDPE masterbatch pellet of composition shown in Table 3 and an LDPE masterbatch pellet containing 5% by mass of ultramarine blue where both of LDPE masterbatch pellets were mixed so that the final composition became as shown in Table 4, was laminated by extruding in a single layer using the cooling roll of which surface roughness of matte surface was 0.7 μm, at linear speed 250 m/min, and thereby disposed the right surface polyethylene resin layer of 29 μm thick.

After that, on the right surface and on the back surface, corona discharge treatment of 18 kW and 12 kW, were performed respectively. Then, on the right surface and on the back surface, gelatin undercoating layer of 0.06 g/m² at dry mass and gelatin undercoating layer of 0.038 g/m² at dry mass, were disposed respectively. Thereby, support was prepared.

TABLE 3

| Composition | Content (% by mass) |
|---|---|
| LDPE (ρ = 0.921 g/cm³) | 37.98 |
| Anatase titanium dioxide | 60.00 |
| Zinc stearate | 2.00 |
| Anti-oxidant | 0.02 |

TABLE 4

| Composition | Content (% by mass) |
|---|---|
| LDPE (ρ = 0.921 g/cm³) | 67.7 |
| Anatase titanium dioxide | 30.0 |
| Zinc stearate | 2.0 |
| Untramarine blue | 0.3 |

—Preparation of Coating Solution for First Conductive Undercoating Layer—

The following components were mixed to prepare a coating solution for first conductive undercoating layer.
Acrylic latex (HIROS HE-1335, manufactured by SEIKO PMC CORPORATION, breaking extension: 20.4%, glass transition temperature: 15° C.) as a binder resin . . . 10 parts by mass
Spherical fine particles of tin dioxide (SN-38, manufactured by Ishihara Industry Co., Ltd., number average particle diameter: 38 nm) as a conductive metal oxide . . . 4.5 parts by mass
Ion exchange water . . . 10 parts by mass
   <Preparation of Coating Solution for First Image-Receiving Layer>
   —Preparation of Dispersion of Titanium Dioxide—

In a vessel, 48 parts by mass of titanium dioxide (TIPAQUE® R-780-2, manufactured by Ishihara Industry Co., Ltd.), 6 parts by mass of polyvinyl butyral (PVA 205C, manufactured by KURARAY Co., Ltd.), 0.6 parts by mass of a surfactant (Demol EP, manufactured by Kao Corporation), 0.06 parts by mass of carbon black (10B, manufactured by Mitsubishi Chemical Corporation), and 65.6 parts by mass of ion exchange water were mixed. The components were dispersed using NBK-2 manufactured by Nippon Seiki Co., Ltd. to prepare a dispersion of titanium dioxide.

—Preparation of Coating Solution for First Image-Receiving Layer—

In a vessel, 15 parts by mass of the above-mentioned dispersion of titanium dioxide, 10 parts by mass of a carnauba wax water-dispersed compound (CELLOZOL 524, manufactured by Chukyo Oils Co., Ltd.), 200 parts by mass of a water-dispersed polyester resin (solid content: 35% by mass; acid component: terephthalic acid, alcohol component: ethylene glycol, neopentyl glycol, ethylene oxide adduct of bisphenol A, counter cation=NH₄+ (ammonium ion), acid value 18, volume average particle diameter=150 nm, number average molecular mass (Mn)=6000)) as a water dispersible polymer of self-dispersed, 4.8 parts by mass of polyethylene oxide (ALCOX R1000, manufactured by Meisei Chemical Industries Co., Ltd.) as a water-soluble polymer, 1.5 parts by mass of an anionic surfactant (Rapizol A90, manufactured by Nippon Oil & Fats Co., Ltd.), 1.8 parts by mass of fine particles (matting agent, XX08S, manufactured by SEKISUI PLASTICS CO., LTD., average particle diameter=17.4 μm, particle size distribution=0.26), and 128.7 parts by mass of ion exchange water were mixed to prepare a coating solution for first image-receiving layer.

The glass transition temperature (Tg) of water-dispersed polyester resin was 70° C., the melting point of polyethylene oxide was 66° C., and the melting point of carnauba wax water-dispersed compound was 83° C.

—Coating of First Image-Receiving Layer and Coating of First Conductive Undercoating Layer—

On the right surface of the obtained support, the coating solution for first conductive undercoating layer and coating solution for first image-receiving layer were filtered by 400 mesh filter (effective filtration accuracy 40 μm or less), and simultaneously coated double layers by using a slide coater.

The coating solution for first conductive undercoating layer and coating solution for first image-receiving layer were coated so that the coating amount for the first conductive undercoating layer was 2.0 g/m² at dry mass and for the first image-receiving layer was 7.5 g/m² at dry mass. The first conductive undercoating layer and first image-receiving layer, after coating, were dried by the hot air at 100° C. for about 20 seconds to thereby prepare an image-receiving sheet for electrophotography of Example 1. The first image-receiving layer had a thickness of 7 μm, and the first conductive undercoating layer had a thickness of 2 μm.

—Formation of Back Layer—

The surface of the support on which the first image-receiving layer was not formed (back face) was coated with the following composition using a wire coater such that the coating amount after drying was 8.2 g/m², and dried to thereby form a back layer on the back face of the support.
Aqueous acrylic resin (HIROS BH-997L, manufactured by SEIKO PMC CORPORATION, solid content: 28.3% by mass). 100 parts by mass
Paraffin wax (HYDRINE D337, manufactured by Chukyo Oils, solid content: 30% by mass) . . . 4.5 parts by mass
Ion exchange water . . . 33 parts by mass

In this way, the image-receiving sheet for electrophotography of Example 1 was prepared.

### Example 2

—Preparation of Image-Receiving Sheet for Electrophotography—

The image-receiving sheet for electrophotography of Example 2 was prepared in the same manner as in Example 1 except that the added amount of the dispersion of titanium dioxide in the coating solution for first image-receiving layer was changed to 30 parts by mass.

### Example 3

—Preparation of Image-Receiving Sheet for Electrophotography—

The image-receiving sheet for electrophotography of Example 3 was prepared in the same manner as in Example 1 except that the added amount of the dispersion of titanium dioxide in the coating solution for first image-receiving layer was changed to 45 parts by mass.

### Example 4

—Preparation of Image-Receiving Sheet for Electrophotography—

The image-receiving sheet for electrophotography of Example 4 was prepared in the same manner as in Example 1 except that the binder resin (HIROS HE-1335) of the coating solution for first conductive undercoating layer was changed to Nipol SX-1503 (manufactured by ZEON CORPORATION, NBR latex, breaking extension=241.1%, glass transition temperature=−20° C.).

### Example 5

—Preparation of Image-Receiving Sheet for Electrophotography—

The image-receiving sheet for electrophotography of Example 5 was prepared in the same manner as in Example 1 except that the spherical fine particles of tin dioxide (SN-38) of the coating solution for first conductive undercoating layer was changed to needle-shaped particles of tin dioxide (manufactured by Ishihara Industry Co., Ltd., aspect ratio=25, length of short axis=13 nm, length of long axis=320 nm).

### Example 6

—Preparation of Image-Receiving Sheet for Electrophotography—

A first conductive undercoating layer and a first image-receiving layer were formed in the same manner as in Example 1. Instead of disposing a back layer, the surface of the support on which the first image-receiving layer was not formed (back face) was coated with the same coating solution for first conductive undercoating layer and coating solution for first image-receiving layer as those in Example 1 in the same manner to thereby form a second conductive undercoating layer and a second image-receiving layer. The second image-receiving layer had a thickness of 7 μm, and the second conductive undercoating layer had a thickness of 2 μm. In this way, the image-receiving sheet for electrophotography of Example 6 was prepared.

### Example 7

—Preparation of Image-Receiving Sheet for Electrophotography—

The image-receiving sheet for electrophotography of Example 7 was prepared in the same manner as in Example 1 except that the matting agent (XX08S) of the coating solution for first image-receiving layer was changed to a matting agent (CL2080, manufactured by Sumitomo Seika Chemicals Co., Ltd., average particle diameter=10.8 μm, particle size distribution=0.48).

### Comparative Example 1

—Preparation of Image-Receiving Sheet for Electrophotography—

The image-receiving sheet for electrophotography of Comparative Example 1 was prepared in the same manner as in Example 1 except that the added amount of the white pigment (dispersion of titanium dioxide) in the coating solution for first image-receiving layer was changed to 10 parts by mass.

### (Comparative Example 2

—Preparation of Image-Receiving Sheet for Electrophotography—

The image-receiving sheet for electrophotography of Comparative Example 2 was prepared in the same manner as in Example 1 except that the white pigment (dispersion of titanium dioxide) was not added to the coating solution for first image-receiving layer.

### Example 8

—Preparation of Image-Receiving Sheet for Electrophotography—

The image-receiving sheet for electrophotography of Example 8 was prepared in the same manner as in Example 1 except that the binder resin (HIROS HE-1335) of the coating solution for first conductive undercoating layer was changed to HIROS BH-997L (manufactured by SEIKO PMC CORPORATION, acrylic varnish, breaking extension=0.2%, glass transition temperature=65° C.).

### Comparative Example 3

—Preparation of Image-Receiving Sheet for Electrophotography—

The image-receiving sheet for electrophotography of Comparative Example 3 was prepared in the same manner as in Example 1 except that the spherical fine particles of tin dioxide (SN-38) was not added to the coating solution for first conductive undercoating layer.

### Example 9

The image-receiving sheet for electrophotography of Example 9 was prepared in the same manner as in Example 1 except that the added amount of the white pigment (dispersion of titanium dioxide) in the coating solution for first image-receiving layer was changed to 13 parts by mass.

### Comparative Example 4

The image-receiving sheet for electrophotography of Comparative Example 4 was prepared in the same manner as in Example 1 except that the matting agent (XX08S) was not added to the coating solution for first image-receiving layer.

### (Comparative Example 5

The image-receiving sheet for electrophotography of Comparative Example 5 was prepared in the same manner as in Example 1 except that the spherical fine particles of tin dioxide (SN-38) of the coating solution for first conductive undercoating layer was changed to spherical fine particles (number average particle diameter=160 nm).

### Comparative Example 6

The image-receiving sheet for electrophotography of Comparative Example 6 was prepared in the same manner as in Example 1 except that the spherical fine particles of tin dioxide (SN-38) of the coating solution for first conductive undercoating layer was changed to needle-shaped fine particles of tin oxide (aspect ratio=4, length of short axis=13 nm, length of long axis=65 nm).

### Comparative Example 7

The image-receiving sheet for electrophotography of Comparative Example 7 was prepared in the same manner as in Example 1 except that the spherical fine particles of tin dioxide (SN-38) of the coating solution for first conductive undercoating layer was changed to needle-shaped fine particles of tin oxide (aspect ratio=8, length of short axis=60 nm, length of long axis=480 nm).

<Image Forming>

Image forming was carried out on each image-receiving sheet for electrophotography prepared as mentioned above, in the following condition, by means of the apparatus which is the image forming apparatus (DocuCentre Color 500CP, manufactured by Fuji Xerox Co., Ltd.), as shown in FIG. 2, whose fixing unit is modified to an apparatus configured to fix an image and smooth the image surface as shown in FIG. 3. Under the atmosphere of 23° C. and 55% relative humidity, the even image of 10 cm four-way at the highest density of black color was printed and after being printing, fixed by putting the surface of the print upward.

—Belt—

Support of the belt: polyimide (PI) film; width of the belt=50 cm; and the thickness of the belt=80 μm

Material of the releasing layer of the belt: SIFEL610 (manufactured by Shin-Etsu Chemical Co., Ltd.) being a precursor of fluorocarbon siloxane rubber was vulcanized and cured to form a fluorocarbon siloxane rubber-containing layer of 50 μm in thickness on the support.

—Heating and Pressurizing—

Temperature of heat roller: 140° C.

Nip pressure: 130 N/cm²

—Cooling—

Cooler: Length of the heatsink=80 mm

Conveying speed=53 mm/sec

Next, each image-receiving sheet for electrophotography, support, image-receiving layer, and conductive undercoating layer were evaluated as to various properties as follows. Evaluation results are shown in Tables 5 to 8.

<Particle Size Distribution>

The particle size distribution of fine particles (matting agent) of each image-receiving sheet for electrophotography was determined as follows. Specifically, using a particle size analyzer (LA920, manufactured by HORIBA, Ltd.), the arithmetic standard deviation and the arithmetic volume average diameter of the matting agent alone were measured under the condition of ultrasonic dispersion for 2 minutes. Then, the particle size distribution was determined by the following equation 3:
Particle size distribution=(arithmetic standard deviation)/(arithmetic volume average diameter). [Equation 3]
<Breaking Extension>

The breaking extension was determined as follows. Each of the above-mentioned compositions for conductive undercoating layer was applied on a hydrophobic support with a wire bar such that the thickness was 10 μm to 40 μm, and dried to form a conductive undercoating layer. A 5×70 mm strip was cut out as a sample from this conductive undercoating layer, and the measurement was performed for the sample using Tensilon (RTM-50, manufactured by Orientec Co., Ltd.) under the tensile strength of 500 mm/min. The extension at the time when the sample broken relative to an initial sample length was determined as an extended amount (%), or breaking extension.

<Light Transmittance>

The light transmittance was measured by forming an image-receiving layer having a thickness of 100 μm on the polyethylene terephthalate film having a thickness of 100 μm, and measuring the light transmittance of the image-receiving layer using a direct reading haze meter (HGM-2DP, manufactured by Suga Tester Co., Ltd.).

<Surface Electrical Resistance>

The surface electrical resistance was measured according to the method described in JIS K 6911 as follows. The sample of the image-receiving layer was left under the condition where the temperature was 20° C. and the humidity was 65% for 8 hours or more and after applying a voltage of 100 V to the sample of the image-receiving layer for 1 minute under the same condition as the above-noted condition, the surface electrical resistance of the image-receiving layer was measured using a micro-ammeter R8340 (manufactured by Advantest Ltd.).

<Whiteness>

The whiteness was determined according to the method defined in JIS P8123 as follows. Using a Hunter whiteness tester, a ratio (%) of the reflectance when the support or image-receiving layer of each image-receiving sheet for electrophotography as a sample was irradiated with blue-violet light of the spectrum, to the reflectance obtained when a standard magnesium oxide plate was irradiated with the same light was measured. In the present invention, the acceptable level in practical use is “85% or more”.

<Dynamic Friction Coefficient>

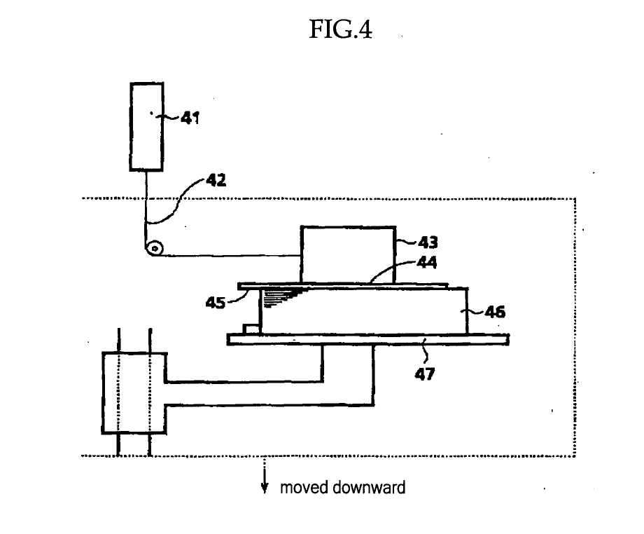

The dynamic friction coefficient between image-receiving sheets for electrophotography was measured using a measuring instrument shown in FIG. 4 as follows. Specifically, stacked 5 sheets 46, in which the image-receiving layer of the image-receiving sheet for electrophotography faced the back face, were placed on a sample stand 47 (the side where the image-receiving layer was formed was placed upward), and one image-receiving sheet for electrophotography 45 was placed thereon in such a way that the sheet 45 was positioned slightly forward of the stacked sheets (the back face was placed downward). A weight 43 that has an adhesive layer 44 on the back side was placed on the image-receiving sheet for electrophotography 45 so that the adhesive layer 44 was in contact therewith. The weight 43 was connected to a load cell 41 with a kite string 42 through a roller so that the weight 43 could be moved forward. The sample stand 47 was moved downward (150 mm/min). From the place where the minimum load was measured after the maximum load, the sample stand 47 was moved further 60 mm, and the average load was obtained as the dynamic friction force. The dynamic friction coefficient was determined according to the calculation method described in JIS-K-7125-1987. The measurement was performed under the following conditions.

[Measuring Condition]

Sample Size: A4 size

Load Cell 41: 1 kg

Moving Speed: 150 mm/min

Load area of weight 43: 76×43 mm

Temperature: 25° C.

Humidity: 55% RH

<Crazing>

An even image of 10 cm four-way at the highest density of black color was printed on the image-receiving sheet for electrophotography using an oilless-fixing color laser printer (C-2220, manufactured by Fuji Xerox Co., Ltd.), and then left under the conditions of 10° C. and a relative humidity of 15% for 1 day. Round bars having a diameter of 1 cm, 2 cm, 3 cm, 4 cm, or 5 cm were prepared, and the image-receiving sheet was wrapped around the bar so that the image face, i.e., the surface on which an image was formed, faced outside, sequentially from the bar with large diameter to the bar with small diameter. The minimum diameter of the round bar which did not cause crazing was recorded. In the present invention, the acceptable level in practical use is “3 cm or less”.

<Conveyability>

100 sheets of the image-receiving sheet for electrophotography were fed continuously using an oilless-fixing color laser printer (C-2220, manufactured by Fuji Xerox Co., Ltd.), and the total number of failure sheets caused by paper feed failure, paper-jamming, and stacking failure was counted. In the present invention, the acceptable level in practical use is “2 sheets or less”.

<Toner Transferability>

The obtained images were visually checked as to transfer nonuniformity of each color of yellow (Y), magenta (M), cyan (C), and black (K), and were evaluated based on the following criteria (sensory evaluation).

[Evaluation Criteria]

3: No color nonuniformity

2: Color nonuniformity was found at 5 spots or less, and the degree of the color nonuniformity was weak

1: Color nonuniformity was found at 6 spots or more, or the degree of the color nonuniformity was strong

TABLE 5

| | | | Example | | | | | |
|---|---|---|---|---|---|---|---|---|
| | | | 1 | 2 | 3 | 4 | 5 | 6 |
| First image- | Fine | Type | XX08S | XX08S | XX08S | XX08S | XX08S | XX08S |
| receiving | particles | Particle size | 0.26 | 0.26 | 0.26 | 0.26 | 0.26 | 0.26 |
| layer | | distribution | | | | | | |
| | | Blended | 1.8 | 1.8 | 1.8 | 1.8 | 1.8 | 1.8 |
| | | amount (parts | | | | | | |
| | | by mass) | | | | | | |
| | White pigment | Blended | 15 | 30 | 45 | 15 | 15 | 15 |
| | dispersion of | amount (parts | | | | | | |
| | titanium dioxide | by mass) | | | | | | |
| | light transmittance (%) | | 60 | 53 | 42 | 60 | 60 | 60 |
| | Surface electrical resistance | | 12.7 | 12.7 | 12.7 | 12.8 | 12.3 | 12.7 |
| | (log Ω/quadrature) | | | | | | | |
| First | Metal oxide | Type | Spherical | Spherical | Spherical | Spherical | Needle- | Spherical |
| conductive | | | fine | fine | fine | fine | shaped | fine |
| undercoating | | | particles of | particles of | particles of | particles of | particles of | particles of |
| layer | | | tin dioxide | tin dioxide | tin dioxide | tin dioxide | tin dioxide | tin dioxide |
| | | | SN-38 | SN-38 | SN-38 | SN-38 | | SN-38 |
| | | Blended | 4.5 | 4.5 | 4.5 | 4.5 | 2 | 45 |
| | | amount (parts | | | | | | |
| | | by mass) | | | | | | |
| | Binder resin | Type | HIROS | HIROS | HIROS | Nipol | HIROS | HIROS |
| | | | HE-1335 | HE-1335 | HE-1335 | SX-1503 | HE-1335 | HE-1335 |
| | | Blended | 10 | 10 | 10 | 10 | 10 | 10 |
| | | amount (parts | | | | | | |
| | | by mass) | | | | | | |
| | Breaking extension (%) | | 20.8 | 20.8 | 20.8 | 241.8 | 20.8 | 20.8 |
| Support | Whiteness (%) | | 90 | 90 | 90 | 90 | 90 | 90 |
| Second | Metal oxide | Type | | | | | | Spherical |
| conductive | | | | | | | | fine |
| undercoating | | | | | | | | particles of |
| layer | | | | | | | | tin dioxide |
| | | | | | | | | SN-38 |
| | | Blended | | | | | | 4.5 |
| | | amount (parts | | | | | | |
| | | by mass) | | | | | | |
| | Binder resin | Type | | | | | | HIROS |
| | | | | | | | | HE-1335 |
| | | Blended | | | | | | 10 |
| | | amount (parts | | | | | | |
| | | by mass) | | | | | | |
| | Breaking extension (%) | | | | | | | 20.8 |
| Second | Fine | Type | | | | | | XX08S |
| image- | particles | Particle size | | | | | | 0.26 |
| receiving | | distribution | | | | | | |
| layer | | Blended | | | | | | 1.8 |
| | | amount (parts | | | | | | |
| | | by mass) | | | | | | |
| | White pigment: | Blended | | | | | | 15 |
| | dispersion of | amount (parts | | | | | | |
| | titanium dioxide | by mass) | | | | | | |

| | | | | | | | |
|---|---|---|---|---|---|---|---|
| | Light transmittance (%) | | | | | | 60 |
| | Surface electrical resistance | | | | | | 12.7 |
| | (log Ω/quadrature) | | | | | | |
| Evaluation | Whiteness (%) | 91 | 92 | 93 | 91 | 92 | 91 |
| results | Crazing (cm) | 2 | 2 | 3 | 1 | 2 | 2 |
| | Conveyability (sheet(s)) | 1 | 0 | 1 | 1 | 0 | 1 |
| | Dynamic friction coefficient | 0.39 | 0.38 | 0.37 | 0.38 | 0.42 | 0.45 |
| | Toner Transferability | 3 | 3 | 3 | 3 | 3 | 3 |

TABLE 6

| | | | | Comp. | Comp. | | Comp. |
|---|---|---|---|---|---|---|---|
| | | | Example 7 | Example 1 | Example 2 | Example 8 | Example 3 |
| First image- | Fine | Type | CL2080 | XX08S | XX08S | XX08S | XX08S |
| receiving | particles | Particle size | 0.48 | 0.26 | 0.26 | 0.26 | 0.26 |
| layer | | distribution | | | | | |
| | | Blended | 1.8 | 1.8 | 1.8 | 1.8 | 1.8 |
| | | amount (parts | | | | | |
| | | by mass) | | | | | |
| | White pigment: | Blended | 15 | 10 | None | 15 | 15 |
| | dispersion of | amount (parts | | | 0 | | |
| | titanium dioxide | by mass) | | | | | |
| | Light transmittance (%) | | 60 | 78 | 92 | 60 | 60 |
| | Surface electrical resistance | | 12.9 | 13.1 | 13.2 | 12.6 | 15.8 |
| | (log Ω/quadrature) | | | | | | |
| First | Metal oxide | Type | Spherical | Spherical | Spherical | Spherical | None |
| conductive | | | fine | fine | fine | fine | |
| undercoating | | | particles of | particles of | particles of | particles of | |
| layer | | | tin dioxide | tin dioxide | tin dioxide | tin dioxide | |
| | | | SN-38 | SN-38 | SN-38 | SN-38 | |
| | | Blended | 4.5 | 4.5 | 4.5 | 4.5 | 0 |
| | | amount (parts | | | | | |
| | | by mass) | | | | | |
| | Binder resin | Type | HIROS | HIROS | HIROS | HIROS | HIROS |
| | | | HE-1335 | HE-1335 | HE-1335 | BH-997L | HE-1335 |
| | | Blended | 10 | 10 | 10 | 10 | 10 |
| | | amount (parts | | | | | |
| | | by mass) | | | | | |
| | Breaking extension (%) | | 20.8 | 20.8 | 20.8 | 0.2 | 20.8 |
| Support | Whiteness (%) | | 90 | 90 | 90 | 90 | 90 |
| Second | Metal oxide | Type | | | | | |
| conductive | | Blended | | | | | |
| undercoating | | amount (parts | | | | | |
| layer | | by mass) | | | | | |
| | Binder resin | Type | | | | | |
| | | Blended | | | | | |
| | | amount (parts | | | | | |
| | | by mass) | | | | | |
| | Breaking extension (%) | | | | | | |
| Second image- | Fine | Type | | | | | |
| receiving | particles | Particle size | | | | | |
| layer | | distribution | | | | | |
| | | Blended | | | | | |
| | | amount (parts | | | | | |
| | | by mass) | | | | | |
| | White pigment: | Blended | | | | | |
| | dispersion of | amount (parts | | | | | |
| | titanium dioxide | by mass) | | | | | |

| | | | | | | |
|---|---|---|---|---|---|---|
| | Light transmittance (%) | | | | | |
| | Surface electrical resistance | | | | | |
| | (log Ω/quadrature) | | | | | |
| Evaluation | Whiteness (%) | 91 | 88 | 86 | 91 | 92 |
| results | Crazing (cm) | 2 | 2 | 1 | 3 | 1 |
| | Conveyability (sheet(s)) | 2 | 0 | 1 | 1 | 7 |
| | Dynamic friction coefficient | 0.54 | 0.39 | 0.41 | 0.39 | 0.68 |
| | Toner Transferability | 3 | 3 | 2 | 3 | 1 |

TABLE 7

| | | | | Comp. | Comp. |
|---|---|---|---|---|---|
| | | | Example 9 | Example 4 | Example 5 |
| First image- | Fine | Type | XX08S | — | XX08S |
| receiving | particles | Particle size | 0.26 | — | 0.26 |
| layer | | distribution | | | |
| | | Blended | 1.8 | — | 1.8 |
| | | amount (parts | | | |
| | | by mass) | | | |
| | White pigment: | Blended | 13 | 15 | 15 |
| | dispersion of | amount (parts | | | |
| | titanium dioxide | by mass) | | | |
| | Light transmittance (%) | | 71 | 62 | 60 |
| | Surface electrical resistance | | 12.7 | 12.7 | 14.8 |
| | (log Ω/quadrature) | | | | |
| First | Metal oxide | Type | Spherical | Spherical | Spherical fine |
| conductive | | | fine | fine | particles of tin |
| undercoating | | | particles of | particles of | dioxide, number |
| layer | | | tin dioxide | tin dioxide | average particle |
| | | | SN-38 | SN-38 | diameter = |
| | | | | | 160 nm |
| | | Blended | 4.5 | 4.5 | 4.5 |
| | | amount (parts | | | |
| | | by mass) | | | |
| | Binder resin | Type | HIROS | HIROS | HIROS |
| | | | HE-1335 | HE-1335 | HE-1335 |
| | | Blended | 10 | 10 | 10 |
| | | amount (parts | | | |
| | | by mass) | | | |
| | Breaking extension (%) | | 20.8 | 20.8 | 20.8 |
| Support | Whiteness (%) | | 90 | 90 | 90 |
| Second | Metal oxide | Type | | | |
| conductive | | Blended | | | |
| undercoating | | amount (parts | | | |
| layer | | by mass) | | | |
| | Binder resin | Type | | | |
| | | Blended | | | |
| | | amount (parts | | | |
| | | by mass) | | | |
| | Breaking extension (%) | | | | |
| Second image- | Fine | Type | | | |
| receiving | particles | Particle size | | | |
| layer | | distribution | | | |
| | | Blended | | | |
| | | amount (parts | | | |
| | | by mass) | | | |
| | White pigment: | Blended | | | |
| | dispersion of | amount (parts | | | |
| | titanium dioxide | by mass) | | | |

| | | | | |
|---|---|---|---|---|
| | Light transmittance (%) | | | |
| | Surface electrical resistance | | | |
| | (log Ω/quadrature) | | | |
| Evaluation | Whiteness (%) | 90 | 91 | 85 |
| results | Crazing (cm) | 2 | 2 | 2 |
| | Conveyability (sheet(s)) | 1 | 9 | 1 |
| | Dynamic friction coefficient | 0.39 | 0.56 | 0.39 |
| | Toner Transferability | 3 | 3 | 1 |

TABLE 8

| | | | Comp. | Comp. |
|---|---|---|---|---|
| | | | Example 6 | Example 7 |
| First image- | Fine | Type | XX08S | XX08S |
| receiving | particles | Particle size | 0.26 | 0.26 |
| layer | | distribution | | |
| | | Blended | 1.8 | 1.8 |
| | | amount (parts | | |
| | | by mass) | | |
| | White pigment: | Blended | 15 | 15 |
| | dispersion of | amount (parts | | |
| | titanium dioxide | by mass) | | |
| | Light transmittance (%) | | 60 | 60 |
| | Surface electrical resistance | | 15.8 | 14.5 |
| | (log Ω/quadrature) | | | |
| First | Metal oxide | Type | Needle-shaped fine | Needle-shaped fine |
| conductive | | | particles of tin oxide | particles of tin oxide |
| undercoating | | | (aspect ratio = 4, | (aspect ratio = 8, |
| layer | | | short axis = 13 nm, | short axis = 60 nm, |
| | | | long axis = 65 nm) | long axis = 480 nm) |
| | | Blended | 4.5 | 4.5 |
| | | amount (parts | | |
| | | by mass) | | |
| | Binder resin | Type | HIROS HE-1335 | HIROS HE-1335 |
| | | Blended | 10 | 10 |
| | | amount (parts | | |
| | | by mass) | | |
| | Breaking extension (%) | | 20.8 | 20.8 |
| Support | Whiteness (%) | | 90 | 90 |
| Second | Metal oxide | Type | | |
| conductive | | Blended | | |
| undercoating | | amount (parts | | |
| layer | | by mass) | | |
| | Binder resin | Type | | |
| | | Blended | | |
| | | amount (parts | | |
| | | by mass) | | |
| | Breaking extension (%) | | | |
| Second image- | Fine | Type | | |
| receiving | particles | Particle size | | |
| layer | | distribution | | |
| | | Blended | | |
| | | amount (parts | | |
| | | by mass) | | |
| | White pigment: | Blended | | |
| | dispersion of | amount (parts | | |
| | titanium dioxide | by mass) | | |

| | | | |
|---|---|---|---|
| | Light transmittance (%) | | |
| | Surface electrical resistance | | |
| | (log Ω/quadrature) | | |
| Evaluation | Whiteness (%) | 88 | 84 |
| results | Crazing (cm) | 2 | 2 |
| | Conveyability (sheet(s)) | 4 | 3 |
| | Dynamic friction coefficient | 0.39 | 0.39 |
| | Toner Transferability | 1 | 1 |

The evaluation results shown in Tables 5 to 8 show that any of the image-receiving sheets for electrophotography of Examples 1 to 9 was excellent in toner transferability, conveyability, and whiteness of the surface of the image-receiving layer, and did not cause cracks in the image when bended as compared to the image-receiving sheets for electrophotography of Comparative Examples 1 to 7.

The image-receiving sheet for electrophotography of the present invention is excellent in toner transferability, conveyability, and whiteness of the surface of the image-receiving layer without causing cracks in the image when bended, and thus the image-receiving sheet for electrophotography can be used for various image forming apparatuses and can form high-quality images close to silver halide photography prints.

What is claimed is:

1. An image-receiving sheet for electrophotography, comprising:
a support;
conductive undercoating layer; and
an image-receiving layer on at least one surface of the support via the conductive undercoating layer,
wherein the conductive undercoating layer comprises a conductive metal oxide and a binder resin,
wherein, when the conductive metal oxide has a spherical shape or an irregular shape, the number average particle diameter of the conductive metal oxide is 0.15 μm or less, and when the conductive metal oxide has a needle-shape or a substantially needle-shape, the aspect ratio, length of long axis/length of short axis, of the conductive metal oxide is 5 or more, and the length of short axis is from 0.005 μm to 0.05 μm, and
wherein the image-receiving layer comprises a white pigment and fine particles, and the light transmittance of the image-receiving layer is 75% or less.

2. The image-receiving sheet for electrophotography according to claim 1, wherein the image-receiving layer is disposed on both surfaces of the support via the conductive undercoating layer.

3. The image-receiving sheet for electrophotography according to claim 1, wherein a whiteness W_{S} of a surface of the support and a whiteness W_{R} of a surface of the image-receiving layer satisfy: |W_{S}|W_{R}|≦<0.5.

4. The image-receiving sheet for electrophotography according to claim 1, wherein a whiteness W_{S} of a surface of the support and a whiteness W_{R} of a surface of the image-receiving layer satisfy: W_{S}−W_{R}<0.5.

5. The image-receiving sheet for electrophotography according to claim 1, wherein the fine particles have a particle size distribution, arithmetic standard deviation/arithmetic volume average diameter, of 0.4 or less.

6. The image-receiving sheet for electrophotography according to claim 1, the conductive undercoating layer has a breaking extension of 20% or more.

7. An image forming process comprising:
forming a toner image on a surface of an image-receiving sheet for electrophotography, and
fixing the toner image formed in the formation of the toner image on the image-receiving sheet for electrophotography to smooth the surface of the toner image,
wherein the image-receiving sheet for electrophotography comprises a support, a conductive undercoating layer, and an image-receiving layer on at least one surface of the support via the conductive undercoating layer, wherein the conductive undercoating layer comprises a conductive metal oxide and a binder resin, wherein, when the conductive metal oxide has a spherical shape or an irregular shape, the number average particle diameter of the conductive metal oxide is 0.15 μm or less, and when the conductive metal oxide has a needle-shape or a substantially needle-shape, the aspect ratio, length of long axis/length of short axis, of the conductive metal oxide is 5 or more, and the length of short axis is from 0.005 μm to 0.05 μm, and wherein the image-receiving layer comprises a white pigment and fine particles, and the light transmittance of the image-receiving layer is 75% or less.

8. The image forming process according to claim 7, wherein the fixing a toner image to smooth the surface of the toner image comprises heating, pressurizing, cooling the toner image, and peeling the toner image-receiving sheet from a belt using an apparatus configured to fix an image and smooth the image surface which is equipped with a heating and pressurizing member, a belt, and a cooling unit.
